(19) United States
(12) Patent Application Publication
(10) Pub. No.: US 2002/0057333 A1
(43) Pub. Date: May 16, 2002

(54) Video conference and video telephone system, transmission apparatus, reception apparatus, image communication system, communication apparatus, communication method

(76) Inventor: Ichiko Mayuzumi, Kanagawa (JP)

Correspondence Address: MORGAN & FINNEGAN, L.L.P., 345 PARK AVENUE, NEW YORK, NY, 10154, US

(21) Appl. No.: 09/870,910

(22) Filed: May 31, 2001

(30) Foreign Application Priority Data
Jun. 2, 2000 (JP) 166686/2000
May 21, 2001 (JP) 151181/2001

(51) Int. Cl. H04N 7/14

(52) U.S. Cl. 348/14.1

(57) ABSTRACT

A video conference and video telephone system in which audio is made stereo and which includes transmission and reception apparatuses is achieved. The transmission apparatus has a transmission unit for transmitting data obtained by addition of two audio signals of L and R channels as monaural audio through a first communication channel and data obtained by subtraction of the two audio signals as nonstandard audio. The reception apparatus has a reception unit for receiving the data obtained by the addition of the two audio signals as the monaural audio data and the data obtained by the subtraction of the two audio signals as the nonstandard audio, and a restoring unit for restoring the audio signal by performing an arithmetic operation on the basis of the received data.

### BACKGROUND OF THE INVENTION

1. Field of the Invention

The present invention relates to a video conference and video telephone system which performs multimedia communication based on packets, an image communication system, a communication apparatus, a communication method, a recording medium, and a program.

2. Related Background Art

In a conventional video conference and video telephone system, communication is performed mainly by using an ISDN (Integrated Services Digital Network) line on the basis of H.320 Standard of ITU-T (International Telecommunication Union Telecommunication standardization sector) recommendation. In this system, the ISDN line must be installed, and a toll of the ISDN line is expensive due to its meter rate system. Thus, this system does not spread a little, and usage thereof has been limited to specific usage such as common usage within a conference room of a company, or the like.

Against this, recently, a new standard for the video conference system called H.323 Standard of ITU-T recommendation in which a LAN (local area network) is used appeared, it came to be able to easily achieve the video conference by the LAN in the company. In this case, each user uses an H.323 video conference system corresponding to the LAN, whereby data communication can be performed without connection fees in the same LAN. Namely, only when the data communication is performed to the existing ISDN-based video conference system, such the data communication is performed through a common gateway, and thus the toll of the ISDN line is charged according to the meter rate system.

However, if there is a connection through the Internet and the other party also introduces the H.323 video conference system, the above gateway is unnecessary.

Further, since a faster LAN is advanced and thus a LAN based on 100Base-T of transfer rate 100 Mbps class is also spreading, a connection of transfer rate 1 Mbps class has been achieved in a local video conference connection, whereby image quality of such a video conference system is remarkably improved as compared with that of a conventional video conference system of 2B 128 Kbps based on the ISDN.

Further, since spreading of the faster Internet started, connection speed between the LAN's is rapidly improved. Thus, when the video conference between the H.323 video conference systems is performed through the Internet, the obtained image quality is exceeding the image quality for the video conference through the ISDN.

Incidentally, when the video conference can be achieved without a problem of communication toll, a demand from a one-to-one conference (or a point-point connection conference) to a multipoint conference (or a group conference) comes out.

Since the line toll increases in proportion to the number of conference participants in the conventional ISDN-based H.320 system, this system has an extremely luxurious function when thinking about costs of the communication lines. Further, since the band of the line is narrow, communication quality is unexcellent.

On the other hand, since the line toll is unnecessary in the LAN-based H.323 system, a need for multipoint conference is inevitably caused in this system.

Further, when it pays attention to the point of audio (or voice), the ISDN-based H.320 system is a standard only of monaural. For this reason, when it is intended to achieve stereo, audio data (or voice data) erodes the band of video data (or image data) in case of the basic 2B connection, whereby image quality is deteriorated. On the other hand, in the LAN-based H.323 system, particularly in the same LAN, since a data transfer rate is high (10 Mbps, 100 Mbps, etc.), on the data transfer any serious problem is not caused even if the band increases because the audio data is made stereo.

Thus, if it is intended to make the audio data stereo and achieve the group conference, later-described problems are caused in the specification described in the latest H.323 Standard Book (TTC (Telecommunication Technology Committee) Standard JT-H.323 Ver. 2.1).

A group telephone and communication system includes two systems, i.e., a centralized multipoint connection system, and a non-centralized multipoint connection system.

First, in the group conference system, the non-centralized multipoint connection system which can be most simply achieved will be explained hereinafter by way of example. In H.323 Standard, since video and audio are transmitted/received respectively on independent packets, the explanation of the video will be omitted here.

FIG. 5 shows a configuration of the non-centralized multipoint connection. In case of the non-centralized multipoint connection, for example, a case where there are three participants A, B and C is thought. In FIG. 5, a termination point which generates an information stream of a terminal (i.e., the participant) A is shown as an end point A 501.

Similarly, a termination point which generates an information stream of a terminal (i.e., the participant) B is shown as an end point B 502, and a termination point which generates an information stream of a terminal (i.e., the participant) C is shown as an end point C 503. When the multipoint connection is performed, a multipoint controller (MC) which performs multipoint control is necessary. The function of this MC may be achieved by a multipoint processor (MPU) or the terminal itself participating in the conference. In FIG. 5, although a MC 504 is independently shown for intelligibility, it is assumed that the MC is actually included in the terminal (the end point).

The terminal A notifies beforehand each participant of holding of the group conference by means of, e.g., an electronic mail or the like. The MC 504 existing in the terminal A performs setting to convene the conference. Next, the end point A 501 performs call setting to the MC 504. After the call setting was performed, the end point A 501 performs capability exchange to other terminals according to H.245 Standard for a multimedia communication control protocol.

The end point B 502 and the end point C 503 being other participants also perform call setting to the MC 504 and perform capability exchange to other terminals according to H.245 Standard. The MC 504 gathers and composites all participants' capabilities, selects therefrom the common capability, e.g., audio according to G.711 Standard for an audio compression system as a selection communication mode (SCM) in this case, transmits the selected SCM by using a communication mode command, describes this SCM in a communication mode table 520, and then transmits the SCM to the respective end points through 507, 508 and 509. It should be noted that this SCM is described in the communication mode table 520 in the form of an entry 1.

The contents of the communication mode table 520 include SESSION ID (=1) representing a session, SESSION DESCRIPTION (=audio) representing session contents, DATA TYPE (=G.711 monaural) representing a data type, MEDIA CHANNEL (=MCA 1 505) representing a multicasting address for transmitting audio data, and MEDIA CONTROL CHANNEL (=MCA 2 506) representing a multicasting address for transmitting audio control data.

Then, each participant's terminal starts to transmit audio and thus starts multicasting. The end point A 501 transmits the audio data to the MCA 1 505 through 510, and transmits the audio control data to the MCA 2 506 through 513.

Similarly, the end point B 502 transmits the audio data to the MCA 1 through 511, and transmits the audio control data to the MCA 2 through 514. Further, the end point C 503 transmits the audio data to the MCA 1 through 512, and transmits the audio control data to the MCA 2 through 515.

For example, the end point A 501 receives multicasting audio channels, executes an audio mixing function, and thus can provide a composited audio signal to the user.

As described above, a non-centralized multipoint conference is completed. If the terminal A being the convener performs end setting, the conference ends. Of course, the participant can arbitrarily retire from the conference but can not end the conference. The above is the operation of the non-centralized multipoint conference using monaural audio.

On the other hand, in the centralized multipoint connection system, a multipoint control unit (MCU) or a terminal capable of achieving an MCU function is necessary. In this conference, each of all the terminals participating in the group telephone and conference communicates with the MCU in a point-point manner. Each terminal transmits its control stream, audio stream, video stream and data stream to the MCU. The MCU performs various processes such as compositing and the like to the received data, and then transmits the processed data to each terminal.

Further, in the centralized multipoint connection system, each participant's terminal multicasts audio data and video data to all of other participant's terminals. It is necessary for each terminal to composite the received audio stream and select one or plural video streams to be displayed.

Besides, there is a mixing multipoint connection system that the plural group telephone and conference systems are appropriately combined. In this system, the plural terminals participating in this conference in the centralized multipoint connection system and the plural terminals participating in this conference in the non-centralized multipoint connection system together perform the group telephone and conference.

In the video telephone and conference using H.323 Standard, since each of the audio stream and the video stream is transmitted/received in the form of independent packet, only the audio will be explained hereinafter.

FIG. 15 shows topology of the group telephone and conference according to the centralized multipoint connection. In this centralized multipoint connection, as described above, an MCU 1601 is necessary. In this group telephone and conference, each of participant three terminals A 1602, B 1603 and C 1604 communicates with the MCU 1601 in a point-point manner.

Generally, the MCU has one multipoint controller (MC) and plural multipoint processors (MP's). The MCU 1601 in FIG. 15 has one MC and one MP managing the audio data.

In order to perform the group conference, the MC existing in the MCU performs setting to convene the conference. Each of the terminals A 1602, B 1603 and C 1604 participating in this conference first performs call setting to the MC, and then performs capability exchange to other terminals according to H.245 Standard. Thus, the MC gathers and composites all participants' capabilities, selects therefrom the common capability as a selection communication mode (SCM).

Then, each terminal transmits the audio data to the MCU by using the SCM determined as a result of the capability exchange.

The MP in the MCU performs a gathering process to the audio data received from the respective terminals. The MP composites the plural received audio data, performs a predetermined process thereto, and then multicasts the audio data converted to the SCM mode to the respective terminals.

When the MCU being the convener of the conference performs end setting, the conference ends. Of course, each participant's terminal can arbitrarily retire from the conference but can not end the conference.

On the other hand, if it is intended to perform the multipoint conference that the audio is made stereo, following problems are caused. Namely, according to Paragraph 10.4.1 in latest JT-H.323 Standard Book Ver. 2.1, it is defined that an identical packet includes two-channel (L and R channels) audio. Thus, if it is intended to achieve stereo audio by such a manner, the following problems are caused.

(1) In a case where each of the terminals A and B has a stereo audio capability but the terminal C merely has a monaural audio capability, it is necessary for the terminals A and B to simultaneously support monaural audio and stereo audio.

This means increase of the number of channels, whereby it is necessary to decrease audio quality on a network where an upper limit exists in bandwidth, and it is necessary for each terminal to spend more audio processing time. If monaural audio communication is set among the terminals A, B and C to prevent such the problems, the terminals A and B can perform only the monaural communication with the stereo capability, whereby there is a drawback of ruining presence.

(2) While the stereo audio communication is being performed, if the terminal A is changed from a stereo audio source to a monaural audio source, the audio source transmitted from the terminal A is monaural. Even in such a case, the terminal A must perform a stereo audio transmission process and the terminal B must perform a stereo audio reception process. In this case, if an H.245 command (a multimedia communication control protocol) is newly added to the standard, the terminal A notifies the terminal B that the terminal A was changed to the monaural audio source, the stereo audio connection is disconnected, and the monaural audio connection is reset, then the audio can be made monaural to save the band. However, in this case, there is a drawback that the processing operation becomes complex.

It is rare that all the terminals participating in the group telephone and conference have the same processing capability. For example, when it pays attention to the number of audio channels, the terminals A and B are the terminals each having the stereo signal processing capability, and the terminal C is the terminal having the monaural signal processing capability. Thus, at this time, data 1605 transmitted from the terminal A 1602 to the MCU 1601 is the stereo audio composed of L audio data and R audio data, data 1606 transmitted from the terminal B 1603 to the MCU 1601 is the stereo audio composed of L audio data and R audio data, and data 1607 transmitted from the terminal C 1604 to the MCU 1601 is a monaural signal. Thus, in this group telephone and conference, the MCU 1601 multicasts audio data 1608 in which the signals obtained by making the audio signals of the terminals A and B monaural and the audio signal of the terminal C have been added to others.

As described above, when the group telephone and conference is performed in the situation that the stereo and monaural terminals mixedly exist, even if the terminal (e.g., the terminal A or B) has the stereo signal processing capability, this terminal can do nothing but receive the monaural signal.

### SUMMARY OF THE INVENTION

An object of the present invention is to solve all or at least one of the above problems.

Another object of the present invention is to achieve a video conference and video telephone system which solves the above problems and makes audio stereo.

Still another object of the present invention is to provide a system which deals with stereo audio as a whole irrespective of whether each terminal constituting this system deals with stereo audio or monaural audio, and thus efficiently uses lines.

Under the above objects, according to one aspect of the present invention, it is provided a video conference and video telephone system which includes transmission and reception apparatuses for performing communication of two audio signals of L and R channels, wherein

the transmission apparatus comprises

a transmission means for transmitting data obtained by addition of the two audio signals as first audio data through a first communication channel, and transmitting data obtained by subtraction of the two audio signals as second audio data through a second communication channel, and

the reception apparatus comprises

a reception means for receiving the data obtained by the addition of the two audio signals as the first audio data and the data obtained by the subtraction of the two audio signals as the second audio data, and

a restoring means for restoring the audio signal by performing an arithmetic operation on the basis of the audio data received by the reception means.

According to another aspect of the present invention, it is provided a transmission apparatus in a video conference and video telephone system which has a transmission means for transmitting packet data obtained by addition of two audio signals of L and R channels through a first communication channel, and transmitting packet data obtained by subtraction of the two audio signals through a second communication channel.

According to still another aspect of the present invention, it is provided a reception apparatus in a video conference and video telephone system which has a reception means for receiving packet data obtained by addition of two audio signals of L and R channels and/or packet data obtained by subtraction of the two audio signals, and a restoring means for restoring the audio signal by performing an arithmetic operation on the basis of the packet data received by the reception means.

According to still another aspect of the present invention, it is provided a communication apparatus which has a transmission means for transmitting packet data obtained by addition of two audio signals of L and R channels through a first communication channel and packet data obtained by subtraction of the two audio signals through a second communication channel, a reception means for receiving the packet data obtained by the addition of the two audio signals of the L and R channels and/or the packet data obtained by the subtraction of the two audio signals, and a restoring means for restoring the audio signal by performing an arithmetic operation on the basis of the packet data received by the reception means.

According to still another aspect of the present invention, it is provided a communication method which has a step of transmitting packet data obtained by addition of two audio signals of L and R channels through a first communication channel and packet data obtained by subtraction of the two audio signals through a second communication channel.

According to still another aspect of the present invention, it is provided a communication method in a video conference and video telephone system which has a step (a) of receiving packet data obtained by addition of two audio signals of L and R channels and/or packet data obtained by subtraction of the two audio signals, and a step (b) of restoring the audio signal by performing an arithmetic operation on the basis of the packet data received in the step (a).

According to still another aspect of the present invention, it is provided a communication method which has a step (a) of transmitting packet data obtained by addition of two audio signals of L and R channels through a first communication channel and packet data obtained by subtraction of the two audio signals through a second communication channel, a step (b) of receiving the packet data obtained by the addition of the two audio signals of the L and R channels and/or the packet data obtained by the subtraction of the two audio signals, and a step (c) of restoring the audio signal by performing an arithmetic operation on the basis of the packet data received in the step (b).

According to still another aspect of the present invention, it is provided a computer-readable recording medium which records therein a program to cause a computer to execute a procedure of transmitting packet data obtained by addition of two audio signals of L and R channels through a first communication channel and packet data obtained by subtraction of the two audio signals through a second communication channel.

According to still another aspect of the present invention, it is provided a computer-readable recording medium which records therein a program to cause a computer to execute a procedure (a) of receiving packet data obtained by addition of two audio signals of L and R channels and/or packet data obtained by subtraction of the two audio signals, and a procedure (b) of restoring the audio signal by performing an arithmetic operation on the basis of the packet data received in the procedure (a).

According to still another aspect of the present invention, it is provided a computer-readable recording medium which records therein a program to cause a computer to execute a procedure (a) of transmitting packet data obtained by addition of two audio signals of L and R channels through a first communication channel and packet data obtained by subtraction of the two audio signals through a second communication channel, a procedure (b) of receiving the packet data obtained by the addition of the two audio signals of the L and R channels and/or the packet data obtained by the subtraction of the two audio signals, and a procedure (c) of restoring the audio signal by performing an arithmetic operation on the basis of the packet data received in the procedure (b).

According to the present invention, by performing the communication for the data obtained by the addition of the two audio signals of the L and R channels and the data obtained by the subtraction of the two audio signals, it is possible to deal with both the stereo audio and the monaural audio. In the multipoint conference in which the terminals each having the stereo audio processing capability and the terminals each having the monaural audio processing capability mixedly participate, it is possible between the terminals each having the stereo audio processing capability to restore the stereo audio without increasing a data quantity and wastefully increasing processing capabilities.

In the present invention, it is disclosed an image communication system which is composed of transmission and reception apparatuses performing communication of two audio signals of L and R channels, wherein

the transmission apparatus comprises

a reception means for receiving, from an external apparatus, the two audio signals of the L and R channels and a monaural audio signal,

a transmission means for transmitting data obtained by addition of the received two audio signals and monaural audio signal as first audio data through a first communication channel, and transmitting data obtained by subtraction of the two audio signals as second audio data through a second communication channel, and

the reception apparatus comprises

a reception means for receiving the data obtained by the addition of the two audio signals and monaural audio signal as the first audio data and the data obtained by the subtraction of the two audio signals as the second audio data, and

a restoring means for restoring a stereo audio signal on the basis of the first and second audio data received by the reception means.

Further, in the present invention, it is disclosed a communication apparatus which performs communication with plural external apparatuses, comprising:

a reception means for receiving, from the external apparatus, two audio signals of L and R channels or a monaural audio signal;

a generation means for generating first audio data by addition of the received two audio signals and monaural audio signal and second audio data by subtraction of the two audio signals; and

a transmission means for transmitting the first and second audio data.

Further, in addition to the above structure, it is disclosed a communication apparatus wherein the transmission means transmits the first audio data through a first communication channel and the second audio data through a second communication channel.

Further, in addition to the above structure, it is disclosed a communication apparatus wherein, when the external apparatus at a transmission destination of the transmission means corresponds to stereo audio, the transmission means transmits the first and second audio data to the transmission destination, and when the external apparatus at the transmission destination of the transmission means corresponds to monaural audio, the transmission means transmits the first audio data to the transmission destination without transmitting the second audio data.

Further, in addition to the above structure, it is disclosed a communication apparatus which further comprises an image data communication means for transmitting and receiving image data.

Further, in the present invention, it is disclosed a communication method for an image communication system which is composed of transmission and reception apparatuses performing communication of two audio signals of L and R channels, wherein

in the transmission apparatus, the method comprises

a reception step of receiving, from an external apparatus, the two audio signals of the L and R channels and a monaural audio signal, and

a transmission step of transmitting data obtained by addition of the received two audio signals and monaural audio signal as first audio data through a first communication channel, and transmitting data obtained by subtraction of the two audio signals as second audio data through a second communication channel, and

in the reception apparatus, the method further comprises

a reception step of receiving the data obtained by the addition of the two audio signals and monaural audio signal as the first audio data and the data obtained by the subtraction of the two audio signals as the second audio data, and

a restoring step of restoring a stereo audio signal on the basis of the first and second audio data received in the reception step.

Further, it is disclosed a communication method for a communication apparatus which performs communication with plural external apparatuses, comprising:

a reception step of receiving, from the external apparatus, two audio signals of L and R channels or a monaural audio signal;

a generation step of generating first audio data by addition of the received two audio signals and monaural audio signal and second audio data by subtraction of the two audio signals; and

a transmission step of transmitting the first and second audio data.

Further, in addition to the above structure, it is disclosed a communication method wherein the transmission step transmits the first audio data through a first communication channel and the second audio data through a second communication channel.

Further, in addition to the above structure, it is disclosed a communication method wherein

when the external apparatus at a transmission destination in the transmission step corresponds to stereo audio, the transmission step transmits the first and second audio data to the transmission destination, and

when the external apparatus at the transmission destination in the transmission step corresponds to monaural audio, the transmission step transmits the first audio data to the transmission destination without transmitting the second audio data.

Further, in addition to the above structure, it is disclosed a communication method wherein an image data communication step of transmitting and receiving image data is provided.

Further, it is disclosed a program which causes a computer to achieve a communication method comprising:

a first generation step of generating packet data obtained by addition of two audio signals of L and R channels;

a second generation step of generating packet data obtained by subtraction of the two audio signals; and

a transmission step of transmitting the packet data generated in the first generation step through a first communication channel, and transmitting the packet data generated in the second generation step through a second communication channel.

Other objects and features of the present invention will be clarified through the following description in the specification and the attached drawings.

### BRIEF DESCRIPTION OF THE DRAWINGS

FIG. 1 is a block diagram showing a video conference and video telephone system according to the embodiment of the present invention;

FIG. 2 is a block diagram showing a stereo audio circuit;

FIG. 3 is a schematic diagram of the video conference and video telephone system according to the first embodiment;

FIG. 4 is a block diagram showing a process in an audio DSP (digital signal processor);

FIG. 5 is a schematic diagram of conventional non-centralized multipoint connection;

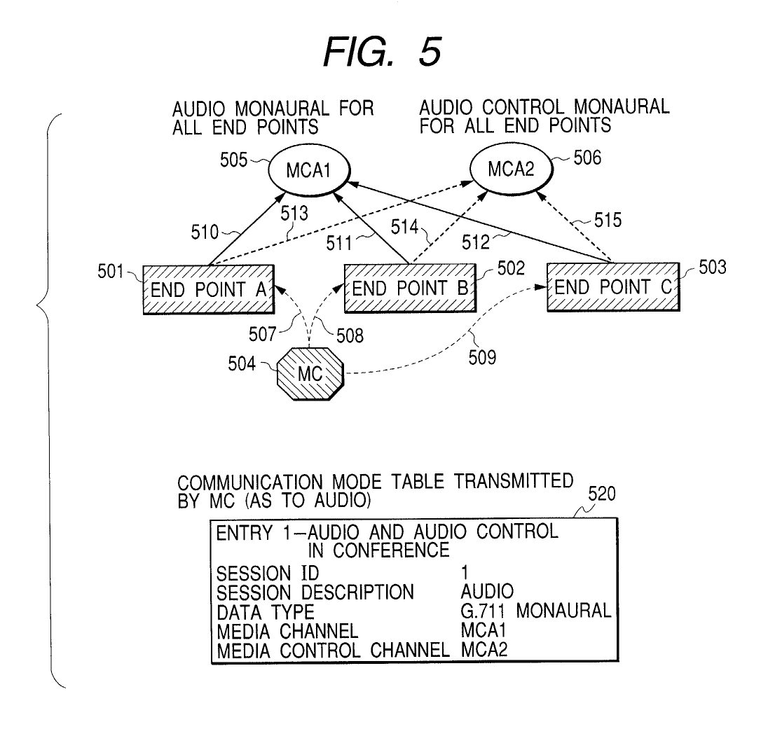

FIG. 6 is a schematic diagram of non-centralized multipoint connection according to the first embodiment;

FIG. 7 is a diagram showing an example of a capability table according to the first embodiment;

FIG. 8 is a diagram showing an example of a capability table of a terminal having a monaural audio processing capability;

FIG. 9 is a diagram showing an example of an RTCP (real time control protocol) sender report packet which is transmitted by the system of the first embodiment;

FIG. 10 is a block diagram showing an audio process in an MCU (multipoint control unit) according to the second embodiment;

FIG. 11 is an internal block diagram showing a stereo video telephone and conference terminal according to the second embodiment;

FIG. 12 is a block diagram showing an internal audio data process in the stereo video telephone and conference terminal according to the second embodiment;

FIG. 13 is a block diagram showing an internal audio data process in a monaural video telephone and conference terminal;

FIG. 14 is a schematic diagram of group telephone and conference which uses centralized multipoint connection according to the second embodiment;

FIG. 15 is a schematic diagram of group telephone and conference which uses conventional centralized multipoint connection;

FIG. 16 is a diagram showing a capability table of a stereo video telephone and conference terminal;

FIG. 17 is a diagram showing a main audio data packet which is multicast by an MCU;

FIG. 18 is a diagram showing a sub audio data packet which is multicast by the MCU;

FIG. 19 is a schematic diagram of group telephone and conference which uses the centralized multipoint connection according to the second embodiment; and

FIG. 20 is a block diagram showing an internal audio data process in the video telephone and conference terminal having an MCU function, according to the second embodiment.

### DESCRIPTION OF THE PREFERRED EMBODIMENTS

[First Embodiment]

The first embodiment of the present invention will be explained hereinafter. A video conference and video telephone system according to the present embodiment has a means which performs a following process in audio data communication.

A transmission side performs an arithmetic operation based on L and R audio signals to generate an (L+R)/2 signal and (L−R)/2 signal, and performs encoding.

Then, on a first audio channel, the transmission side transmits, as standard monaural audio, audio data obtained by encoding the (L+R)/2 signal. On the other hand, on a second audio channel, the transmission side transmits, as nonstandard data, audio data obtained by encoding the (L−R)/2 signal.

In the video conference and video telephone system on a reception side, a terminal which merely has only a monaural audio reception capability or a terminal which wishes to dare to receive the transmitted data as monaural audio receives (L+R)/2 data being the monaural audio on the first audio channel, and decodes the received data to restore or reproduce the audio on the transmission side.

A terminal which wishes to receive the stereo audio receives (L+R)/2 data being the monaural audio and (L−R)/2 data being the nonstandard data on the second audio channel.

Then, data compositing is performed by using time stamps of the (L+R)/2 and (L−R)/2 data, and the composited data is decoded. The (L+R)/2 and (L−R)/2 signals obtained by the decoding are subjected to addition and subtraction processes, whereby the audio on the L and R channels on the transmission side is restored.

By the above means, in the multipoint conference in which the terminals each having the stereo audio processing capability and the terminals each having the monaural audio processing capability mixedly participate, it is possible between the terminals each having the stereo audio processing capability to restore the stereo audio without increasing a data quantity and wastefully increasing processing capabilities.

Further, it is provided the function which controls connection/non-connection of the second audio channel according to whether the audio input source Is the monaural audio input source or the stereo audio input source. Further, notification of such the audio source change is described in a command of H.245 Standard or a capability table, or uses an SDES (source description) of an RTCP (real time control protocol) packet. Thus, between the terminals each having the stereo transmission/reception capability, it is possible to control the connection/non-connection of the second audio channel according to the audio source change between monaural and stereo, whereby the band can be efficiently used.

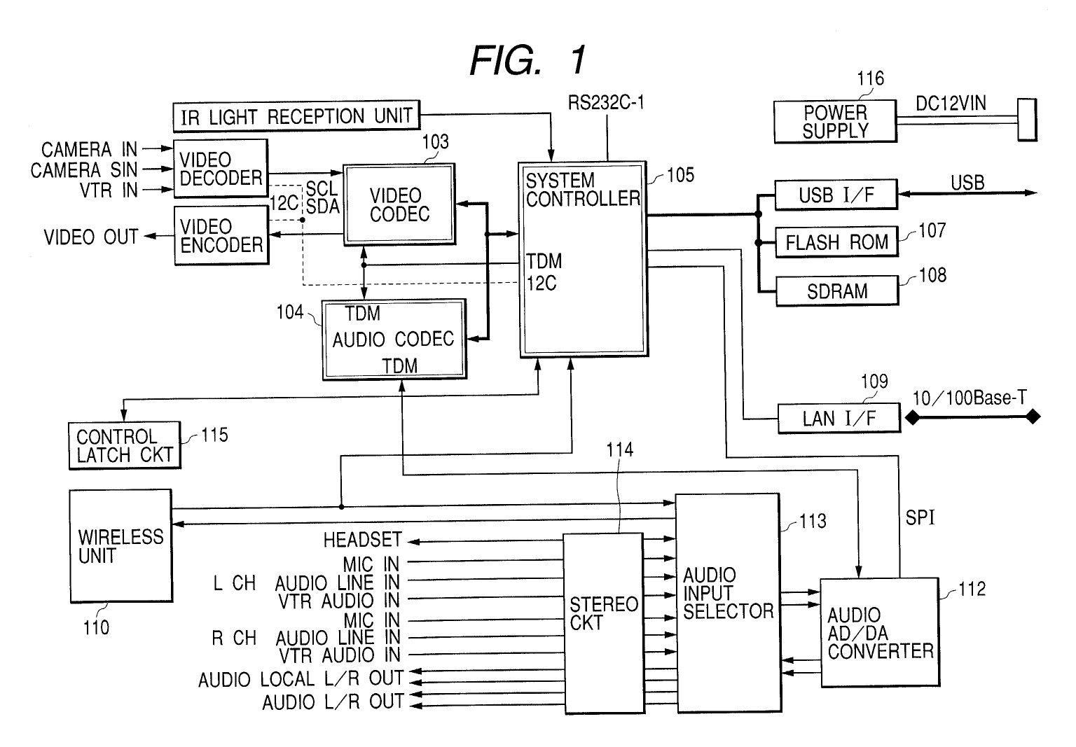

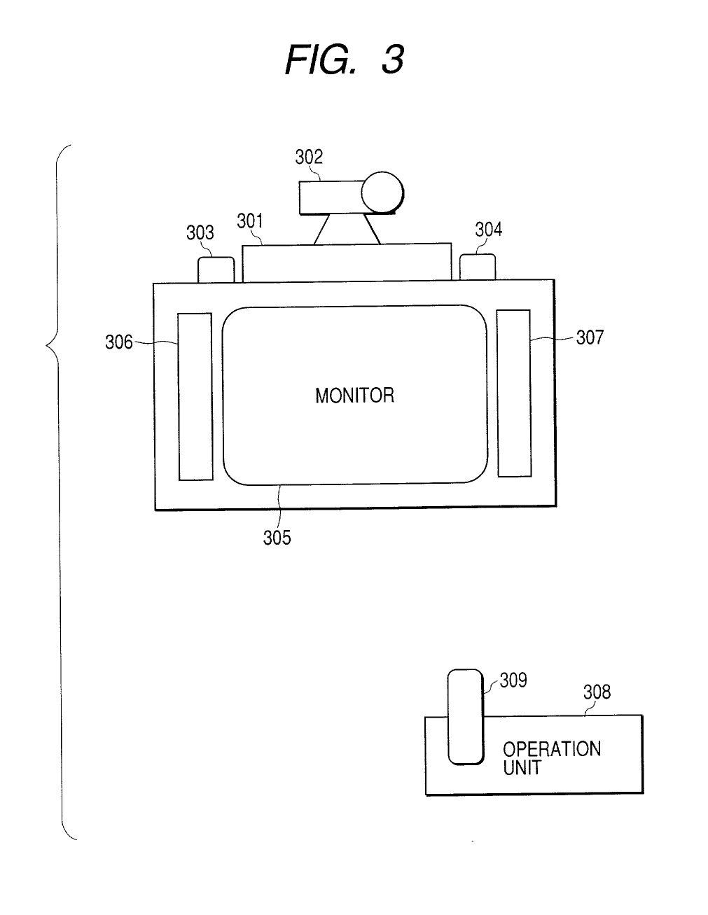

First, an example of hardware of the video conference and video telephone system according to the embodiment of the present invention will be explained with reference to the attached drawings. Next, an operation in a case where the multipoint connection video conference is performed with use of the video conference and video telephone system of the above hardware will be explained. FIG. 1 is a block diagram showing the video conference and video telephone system according to the present embodiment, and FIG. 3 is a schematic diagram of this video conference and video telephone system.

In FIG. 1, when power is supplied from a power supply 116 to the video conference and video telephone system, s system controller 105 reads a predetermined program code for system operation from a flash ROM 107, loads the read program code to an SDRAM (synchronous dynamic random access memory) 108, and actually executes a program. By this program, each block constituting the system is reset and then set to a predetermined initial state. After a video codec (coder-decoder) 103 was reset, the program code for the video codec 103 is read by the system controller 105 from a predetermined area of the flash ROM 107, and the read code is loaded to a not-shown SRAM (static random access memory) in the video codec 103. Subsequently, a predetermined command is sent from the system controller 105 to the video codec 103 to start the loaded program. A similar operation is performed by the system controller 105 to an audio codec 104. After such a series of initialization operations at the start time, the video conference and video telephone system can enter into an ordinary operation state.

After the video conference and video telephone system entered into the ordinary operation state, this system performs a following operation. Namely, as to audio input, an analog video output image generated by a video camera 302 of a terminal 301 of FIG. 3 is supplied to a video decoder 101 (CAMERA IN). Since the video decoder 101 is a multi-input type, plural kinds of video cameras are selectable. In case of selecting one of plural input video signals, for example, a predetermined control signal is sent through a wireless unit 110 from the system controller 105 of FIG. 1 to the video decoder 101 on the basis of a selection signal from an operation switch provided on an operation unit 308 of FIG. 3.

An input video signal from a selected input source is digitized and sent to the video codec 103 by the video decoder 101. Then, in the video codec 103, the obtained digital video signal is subjected to a predetermined process, and an image data quantity is compressed according to a video compression algorithm based on, e.g., H.261 Standard recommended by ITU-T.

On the other hand, with respect to the audio input, for example, an audio signal which was sent from stereo microphones 303 and 304 (MIC IN), an external line (AUDIO LINE IN), a headset (HEADSET), a wireless telephone 309 through the wireless unit 110, or the like is supplied to an audio input selector 113 partially through a stereo circuit 114, and an arbitrary audio input is selected by the selector 113. The audio input selected by the audio input selector 113 is input to an audio AD/DA (analog-to-digital/digital-to-analog) converter 112.

The selection of the audio input source is controlled according as a command is sent from the system controller 105 to a control latch circuit 115 on the basis of an user's working.

The audio signal digitized by the audio AD/DA converter 112 is supplied to the audio codec 104. In the audio codec 104, the obtained digital audio signal is subjected to an audio data compression process based on, e.g., G.711 Standard recommended by ITU-T.

When the video conference is performed over the LAN, the video and the audio are transmitted respectively as different packet data on the basis of H.323 Standard recommended by ITU-T, and they are synchronized with each other by using respective time stamps.

Thus, the video signal compressed by the video codec 103 is sent to the system controller 105, subjected to predetermined fragmentation based on H.225.0 Standard recommended by ITU-T, and then subjected to a predetermined process to create the packet data. On the other hand, the audio signal compressed by the audio codec 104 is similarly sent to the system controller 105, subjected to predetermined fragmentation based on H.225.0 Standard recommended by ITU-T, and then subjected to a predetermined process to create the packet data. Each of the video and audio packet data is transmitted from the system controller 105 to a LAN line through a LAN I/F (interface) 109, and the transmitted data packet is received by a video conference system at a transmission destination, whereby predetermined video and audio are reproduced on this system.

On the other hand, packet data fragmentated based on H.225.0 Standard for partner's video and audio are transmitted from an opposed video conference system and received by the system controller 105 through the LAN I/F 109. In the system controller 105, the fragmentated packet data are restructured respectively into video and audio compression data and then synchronized by using respective time stamps. The restructured compression video data is decoded and restored into the original video signal by the video codec 103.

On the other hand, the restructured audio signal is decoded and restored into the original audio signal by the audio codec 104.

The restored video signal is displayed on a monitor 305. The restored audio signal is converted into the analog audio signal by the audio AD/DA converter 112, and sent to the external line output, the headset, the telephone or the like through the audio input selector 113. Further, for example, the audio signal sent to the external line output is supplied to built-in speakers 306 and 307 of the monitor 305, whereby audio is output.

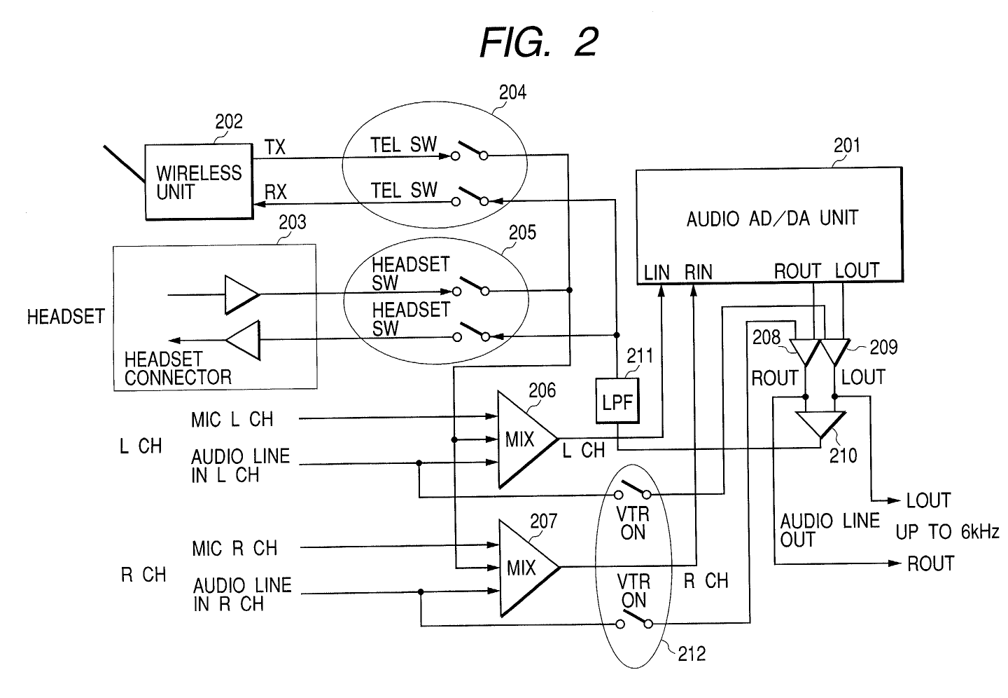

FIG. 2 is a block diagram showing a stereo audio circuit for achieving the stereo audio. In the video conference and video telephone system, there are four audio input routes including a wireless unit (wireless telephone) 202, a headset (HEADSET) through a headset connector 203, a stereo microphone (MIC), and an audio line input (AUDIO LINE IN). Namely, monaural audio input means and stereo audio input means mixedly exist in the video conference and video telephone system.

The above various audio sources (i.e., the microphone input and the audio line input in FIG. 2) are added to others by each of adders (MIX's) 206 and 207 respectively provided on the L and R channels. The audio signals from the adders 206 and 207 are input respectively to L (LIN) and R (RIN) channels of an audio AD/DA unit 201 which composed of an audio A/D converter and an audio D/A converter. When the audio source is the monaural telephone or the monaural headset, the same audio signal is input to both the L and R channels.

If the telephone is selected as the input source, a switch 204 is turned on, while if the headset is selected as the input source, a switch 205 is turned on. The switches 204 and 205 are controlled by the system controller 105 with use of the control latch circuit 115.

Further, in the video conference and video telephone system, there are three audio output routes including the wireless unit (wireless telephone) 202, the headset (HEADSET) through the headset connector 203, and an audio line out (AUDIO LINE OUT). With respect to a signal to be supplied to the telephone or the headset which acts as a monaural output, in consideration of its band, stereo outputs from L (LOUT) and R (ROUT) channels of the audio AD/DA unit 201 are added by an adder 210, band-limited by an LPF (low-pass filter) 211 of 3 kHz, and then output to the telephone or the headset. Further, the stereo outputs from the audio AD/DA unit 201 are output respectively to L (LOUT) and R (ROUT) channels of a terminal (AUDIO LINE OUT) capable of performing stereo outputs.

In a case where the system on the user's own side is selecting a VTR (video tape recorder) audio input, not only the audio on the partner's side (other station) being in the video conference and video telephone communication but also the audio of a VTR must be added to the system audio output. For this reason, when the VTR is used as the audio input source, a switch 212 is turned on, the VTR audio signal is added to the signal output from the audio AD/DA unit 201 by R- and L-channel adders 208 and 209, and the obtained signal is then output from the speaker or the like as the audio output of the video conference system.

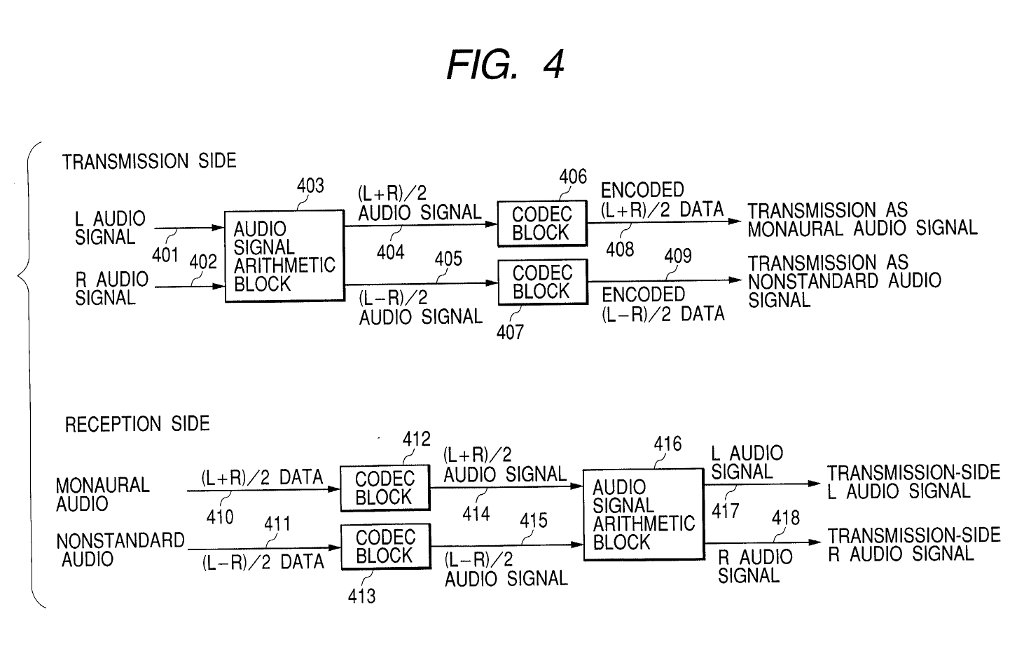

FIG. 4 is a block diagram showing a stereo audio signal process in a DSP (digital signal processor) which processes the audio signal within the system. In order to transmit the stereo audio, following signal processes on blocks are performed.

An L-channel audio signal 401 and an R-channel audio signal 402 are input to an audio signal arithmetic block 403. In the audio signal arithmetic block 403, size-adjusted arithmetic signals, i.e., an (L+R)/2 signal 404 and an (L−R)/2 signal 405, are obtained and output. The (L+R)/2 signal 404 is then encoded by a codec block 406, and encoded (L+R)/2 data 408 is output. This (L+R)/2 data can be managed as a conventional monaural audio signal and is called a standard audio signal.

The (L−R)/2 signal 405 is encoded by a codec block 407, and encoded (L−R)/2 data 409 is output. The output (L−R)/2 data 409 can not be managed as the conventional monaural audio signal (i.e., the standard audio signal) in this video conference system. Thus, the output (L−R)/2 data 409 is transmitted together with discrimination information as a nonstandard audio signal.

Next, in order to receive the above generated stereo audio data, following signal processes on blocks are performed. Namely, the received audio data of the two channels have been synchronized with each other by the system controller 105, and the received audio data is thus decoded and subjected to an arithmetic operation as follows in the audio DSP.

The received monaural audio data, i.e., (L+R)/2 data 410, is decoded by a codec block 412, and a decoded (L+R)/2 audio signal 414 is output.

Further, the received nonstandard audio signal, i.e., (L−R)/2 signal 411, is decoded by a codec block 413, and a decoded (L−R)/2 audio signal 415 is output. The decoded (L+R)/2 audio signal 414 and the decoded (L−R)/2 audio signal 415 are input to an audio signal arithmetic block 416. In the audio signal arithmetic block 416, the input signals are subjected to addition and subtraction processes, whereby an L-channel signal 417 and an R-channel signal 418 being the audio signals on the partner's side are restored.

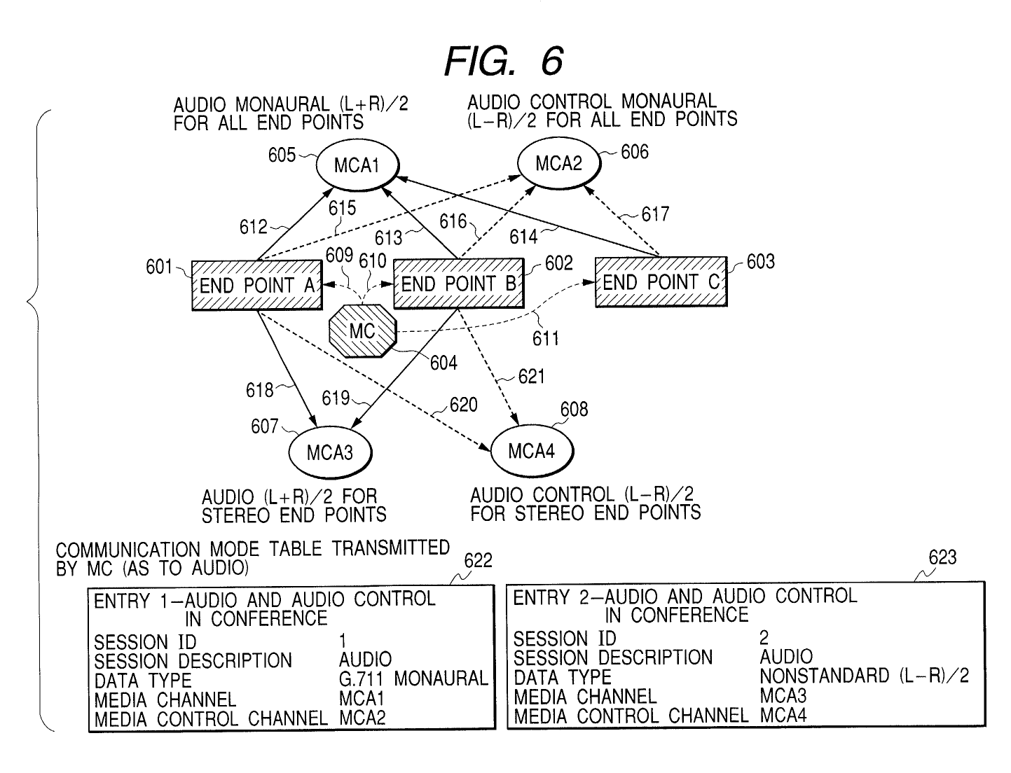

Next, a multipoint conference which uses the video conference system according to the present embodiment will be explained hereinafter. FIG. 6 shows non-centralized multipoint connection which uses the video conference system according to the present embodiment. It is assumed that there are three terminals (parties) A, B and C in the non-centralized multipoint connection.

In FIG. 6, a point of the terminal A which generates and terminates its information stream is called an end point A 601. Similarly, points of the terminals B and C which generate and terminate their information streams are called end points B 602 and C 603, respectively. When the multipoint connection is performed, a multipoint controller (MC) 604 is necessary. However, a multipoint processor (MPU) or the terminal participating in the conference may have a function of the MC 604. In FIG. 6, although the MC 604 is independently shown for intelligibility, it is assumed that the MC 604 is actually included in the terminal A.

The terminal A notifies beforehand each participant of holding of the group conference by means of, e.g., an electronic mail or the like. The terminal A performs setting to convene the conference for the MC 604. Next, the end point A 601 performs call setting to the MC 604. After the call setting was performed, the end point A 601 performs capability exchange to other terminals according to H.245 Standard.

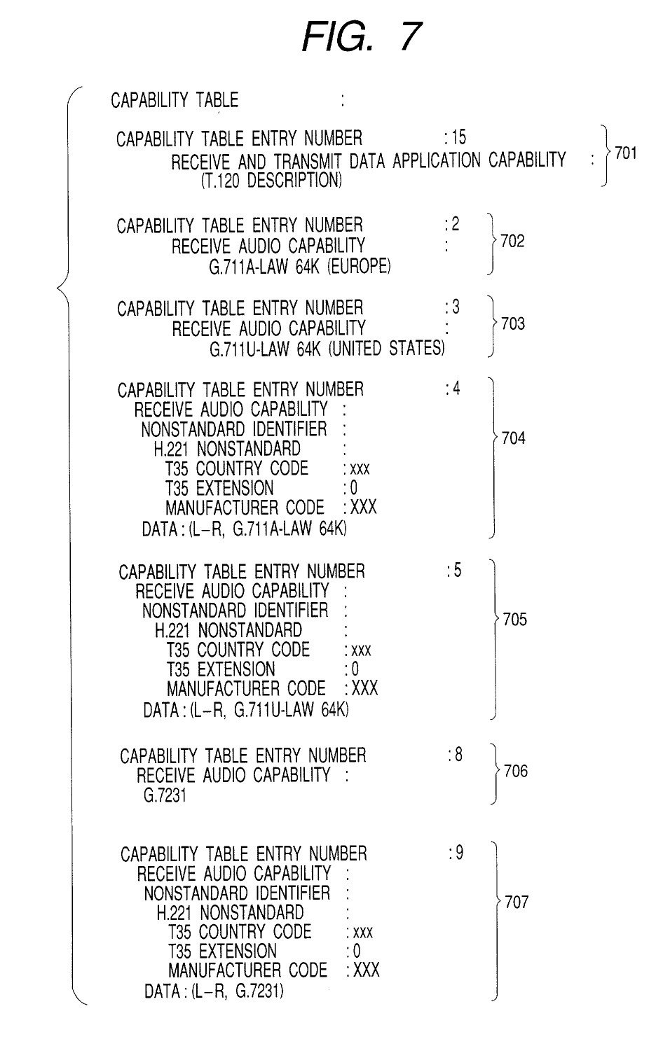

FIG. 7 shows an example of a capability table of the end point A 601 which is used in the capability exchange. In this case, it is assumed that the video conference system at the terminal A has a stereo audio processing capability. In FIG. 7, a description 701 indicates a data conference capability, an environment to be used, and the like, a description 702 indicates a capability for receiving audio G.711A-LAW compressed based on G.711A-LAW Standard being one of audio signal compression systems, and a description 703 indicates a capability for receiving audio G.711U-LAW. The capabilities indicated by the descriptions 702 and 703 aim at monaural audio of one channel. In this system, the (L+R)/2 audio data is transmitted in this channel.

A description 704 indicates nonstandard audio data. Here, the (L−R)/2 audio data encoded based on G711A-LAW Standard is managed.

A description 705 indicates nonstandard audio data. Here, the (L−R)/2 audio data encoded based on G711U-LAW Standard is transmitted through this channel.

A description 706 indicates a capability for receiving audio G.723.1 compressed based on G.723.1 Standard being one of the audio signal compression systems. These descriptions are described together with their parameters (not shown).

A description 707 indicates nonstandard audio data. Here, the (L−R)/2 audio data encoded based on G723.1 Standard is transmitted through this channel.

In the conventional video conference system only corresponding to monaural, the audio G.711A-LAW (description 702), the audio G.711U-LAW (description 703) or the audio G.723.1 (description 706) may be selected in the capability selected. Namely, since the contents of the descriptions 704, 705 and 707 being the nonstandard audio are nonstandard, it is unnecessary to understand them, and any erroneous operation does not occur due to these descriptions.

In FIG. 7, T.120 DESCRIPTION in the description 701 indicates one of standards for describing the data conference capability, the environment to be used, and the like, and H.221 in the description 704 indicates one of video and audio multiplying standards based on H.320 Standard.

Another end point B 602 similarly performs call setting to the MC 604, and then performs capability exchange to other terminals according to H.245 Standard. It is assumed that, like the end point A 601, the video conference system at the end point B 602 has the stereo audio processing capability. Further, another end point C 603 similarly performs call setting to the MC 604, and then performs capability exchange to other terminals according to H.245 Standard.

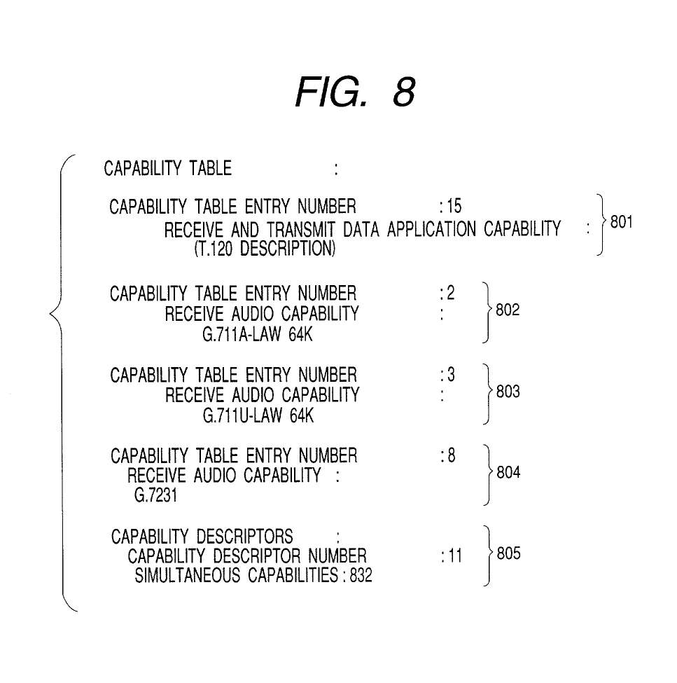

The end point C 603 merely has a monaural audio processing capability, and thus its capability table is shown in FIG. 8. In FIG. 8, a description 801 indicates a data conference capability, a description 802 indicates a capability for receiving audio G.711A-LAW, a description 803 indicates a capability for receiving audio G.711U-LAW, and a description 804 indicates a capability for receiving audio G.723.1. These descriptions are described together with their parameters shown rightward. A description 805 indicates CAPABILITY DESCRIPTORS in which the entry numbers of the capability table are sequentially described from the ability to which it is intended to give priority.

In FIG. 6, the MC 604 integrates all participants' capability sets, and describes two entries in the communication mode table to be transmitted based on a communication mode command, such that the end points A 601 and B 602 select stereo G.711 and the end point C 603 selects monaural G.711. Then, the MC 604 transmits the table to the respective end points (as indicated by arrows 609, 610 and 611). One of the two entries is to manage the (L+R)/2 audio signal, i.e., the monaural audio signal, and the other thereof is to manage the (L−R)/2 audio signal. Entries 1 and 2 which are described in the communication mode table are shown as blocks 622 and 623, respectively.

The entry 1 622 shows SESSION ID (=1) representing a session, SESSION DESCRIPTION (=audio) representing the content of the session, DATA TYPE (=G.711 monaural) representing a data type, MEDIA CHANNEL (=MCA1 605) representing a multicasting address for transmitting audio data, and MEDIA CONTROL CHANNEL (=MCA2 606) representing a multicasting address for transmitting audio control data.

The entry 2 623 shows SESSION ID (=2) representing a session, SESSION DESCRIPTION (=audio) representing the content of the session, DATA TYPE (=nonstandard (L−R)/2) representing a data type, MEDIA CHANNEL (=MCA3 607) representing a multicasting address for transmitting audio data, and MEDIA CONTROL CHANNEL (=MCA4 608) representing a multicasting address for transmitting audio control data.

After then, each participant's terminal turns on its own audio to start multicasting. The end point A 601 transmits the (L+R)/2 audio data to the MCA 1 605 as indicated by numeral 612, and the control data for the (L+R)/2 audio data to the MCA 2 606 as indicated by numeral 615. Further, the end point A 601 transmits the (L−R)/2 audio data to the MCA 3 607 as indicated by numeral 618, and the control data for the (L−R)/2 audio data to the MCA 4 608 as indicated by numeral 620.

Similarly, the end point B 602 transmits the (L+R)/2 audio data to the MCA 1 605 as indicated by numeral 613, and the control data for the (L+R)/2 audio data to the MCA 2 606 as indicated by numeral 616. Further, the end point B 602 transmits the (L−R)/2 audio data to the MCA 3 607 as indicated by numeral 619, and the control data for the (L−R)/2 audio data to the MCA 4 608 as indicated by numeral 621. Since the end point C 603 only has the monaural audio processing capability, the end point C 603 transmits the monaural audio data to the MCA 1 605 as indicated by numeral 614, and the control data for the monaural audio data to the MCA 2 606 as indicated by numeral 617.

It is assumed that each of the end points A 601 and B 602 has a decoding capability for two channels, and the end point C 603 has a decoding capability for one channel. The end point A 601 receives the multicast (L+R)/2 and (L−R)/2 audio data, and performs the predetermined process of FIG. 4 for the received two-channel audio data by using the audio codec within the video conference system so as to reproduce the stereo audio. Similarly, the end point B 602 receives the multicast (L+R)/2 and (L−R)/2 audio data, and performs the predetermined process for the received two-channel audio data by using the audio codec within the video conference system so as to reproduce the stereo audio.

Since the end point C 603 has the decoding capability for one channel, the end point C 603 receives the audio data of the entry 1 (SESSION ID =1), and performs a conventional predetermined process for the received data so as to reproduce the monaural audio signal.

As described above, according to the present embodiment, even in the multipoint conference in which the terminals each having the stereo audio processing capability and the terminals each having the monaural audio processing capability mixedly participate, it is possible between the terminals each having the stereo audio processing capability to transmit and receive the stereo audio.

This means that the video conference system having the stereo audio processing capability can participate in the multipoint conference without lowering its stereo audio processing capability to adjust it to the capability of another terminal. Further, the terminal having the stereo audio processing capability is not required to simultaneously support the monaural audio and the stereo audio (e.g., to generate the monaural audio data in addition to the stereo audio data) for the terminal only having the monaural audio processing capability. For this reason, it is unnecessary to increase a processing capability at each terminal, and it is unnecessary to expand a bandwidth on the network more than necessity. In such a condition, it is possible to achieve the multipoint conference using the stereo audio and create a sound field with full presence.

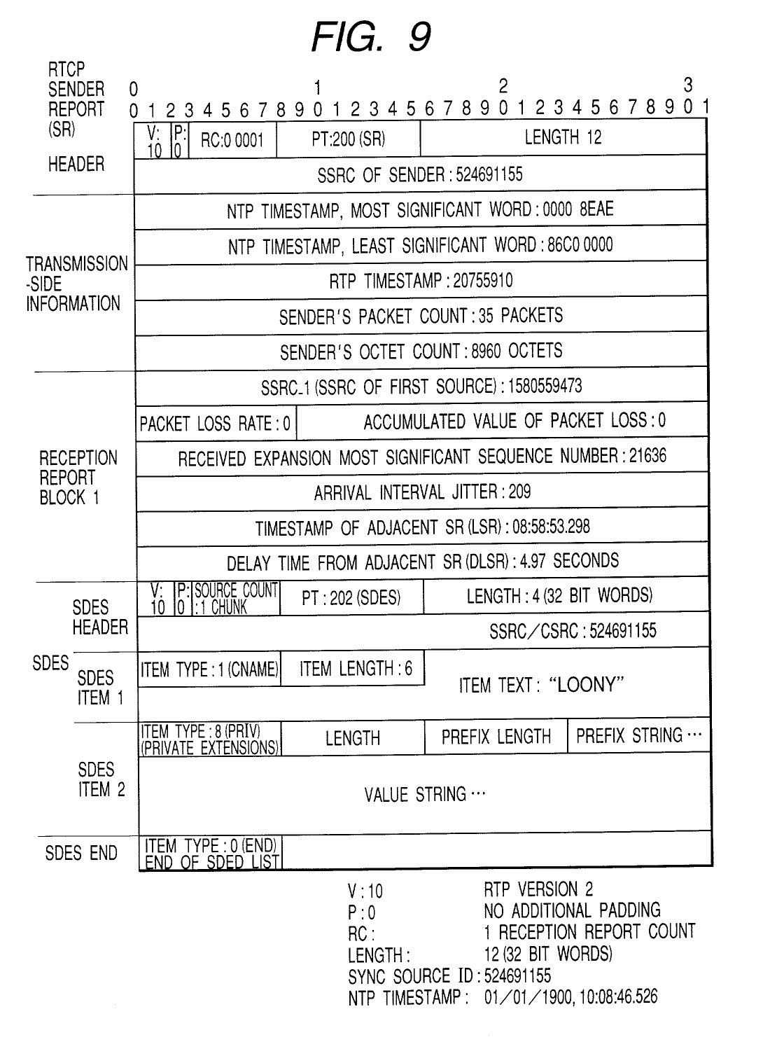

Next, a method by which the terminal having the stereo audio processing capability notifies a communication partner's side that this terminal has the stereo audio processing capability will be explained hereinafter. FIG. 9 shows an RTCP (real time control protocol) packet which is transmitted by the terminal having the stereo audio processing capability, in the above structures such as the multipoint connection, the conference participant's terminal, and the like.

Concretely, FIG. 9 shows a sender report (SR) of the RTCP packet for issuing a control request from the reception side to the transmission side. This packet includes a header, transmission side's information, a reception report block, and a source description (SDES). In the header, information such as a real time protocol (RTP) (=version 2), the packet (=RTCP SR), a payload type (=200), a packet length (=12), SSRC, and the like is described. Further, the SR shows an NTP time stamp, an RTP time stamp, a transmission (sender's) packet count, and a transmission (sender's) octet count, as the transmission side's information. In the reception report block, information such as SSRC, packet loss, an arrival interval jitter, and the like is described. Although the SDES can include some items, the first item should be an SDES header.

In the SDES header, a version and a payload type are described. In the next SDES item, a host name (CNAME) which is necessary to the RTCP packet is described. In the next SDES item, private extensions (PRIV) which represents the video conference system's own capability and audio devices being used is described, whereby it is possible to notify the partner's terminal of such information.

For example, the end point A 601 uses stereo microphones as the audio input device when the conference starts. At this time, the audio data output by the end point A 601 is stereo audio.

In the SDES of the RTCP packet corresponding to the stereo audio data, it is described that the audio is transmitted with two channels. Since the end point B 602 participating in the conference has the stereo audio processing capability, the end point B 602 receives the two-channel data, i.e., the (L+R) and (LR) data, transmitted by the end point A 601 and thus reproduces the stereo audio.

During the conference, when the end point A 601 changes the audio input device from the stereo microphones to headsets, the end point A 601 transmits the monaural audio data through the channel which was used to transmit the (L+R) data before the audio input device was changed. Besides, the end point A 601 stops the data transmission through the channel which was used to transmit the (L−R) data before the audio input device was changed. Further, it is described in the SDES of the RTCP packet corresponding to the audio channel that the number of audio channels is “1”, and this description is notified to the reception side.

On the other hand, the end point B 602 receives the audio RTCP packet transmitted from the end point A 601 and thus detects that the audio of the end point A 601 was changed from the stereo audio to the monaural audio. Thus, the end point B 602 stops the data reception from the L−R channels used till then.

As described above, since the transmission side (the end point A 601) notifies the reception side (the end point B 602) of the number of audio channels, even if the number of audio channels on the transmission side is frequently changed, the number of channels on the reception side can be easily changed only by turning on/off the L−R channels. Thus, the processing capability and the band on the network can be efficiently used.

Further, in the SDES of the RTCP packet concerning the audio transmitted by the end point A 601, the information of the used audio input device is described in addition to the number of audio channels. The other end point participating in the conference receives the RTCP packet and reads the information of the audio input device of the end point A 601, whereby it is possible to notify the user of the audio input device used on the communication partner's side through an application. Thus, the user can know through a display whether the received audio is the monaural audio or the stereo audio.

Since the end point B 602 receives the monaural audio, if the end point B 602 intends to request the stereo audio to the end point A 601, the end point B 602 sends a notification such that the end point A 601 transmits L−R data in response to a mode request of H.245 Standard. Thus, the end point A 601 actually generates and transmits the L−R audio data, whereby the end point B 602 can start the reception of the stereo audio.

As described above, the state that video conference system has the stereo audio processing capability is shown to the partner's terminal, whereby it is possible to easily and automatically change the number of audio channels during the conference.

According to the present embodiment, even in the multipoint conference in which the video conference and video telephone systems each having the stereo audio processing capability and the video conference and video telephone systems each having the monaural audio processing capability mixedly participate, it is possible between the video conference and video telephone systems each having the stereo audio processing capability to transmit and receive the stereo audio. This means that the video conference system having the stereo audio processing capability can participate in the multipoint conference without lowering its stereo audio processing capability to adjust it to the capability of another system or terminal.

Further, the system or terminal having the stereo audio processing capability is not required to generate the monaural audio data in addition to the stereo audio data for the system or terminal only having the monaural audio processing capability. For this reason, it is unnecessary to increase a processing capability at each system or terminal, and it is unnecessary to expand a bandwidth on the network more than necessity. In such a condition, it is possible to efficiently use communication lines, achieve the multipoint conference using the stereo audio, and create a sound field with full presence.

Further, it is assumed that, in the communication between the video conference systems each having the stereo audio processing capability, the transmission side's terminal has the monaural audio input device and the stereo audio input device, and changes these two kinds of audio input devices. In such a case, if one audio channel is changed to two audio channels, the transmission side's terminal notifies the communication partner of the information concerning the audio source change and the channel number change by using the PRIV of the RTCP, and the reception side's terminal (the communication partner) turns on/off the L−R channels in response to the received notification, whereby it is possible to dynamically change the audio process between the terminals from the monaural audio process to the stereo audio process.

[Second Embodiment]

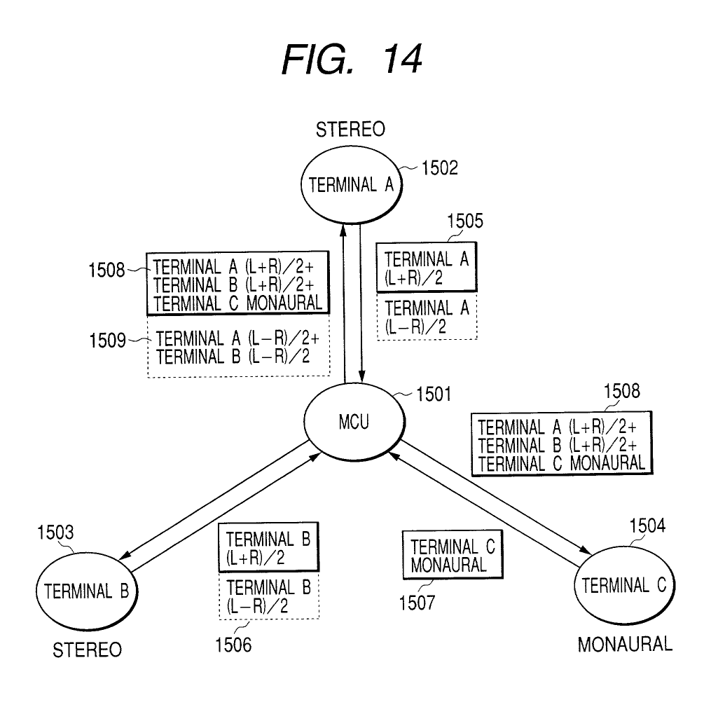

Next, FIG. 14 shows topology of the group telephone and conference according to the centralized multipoint connection. A communication system in the present embodiment is basically the same as that in the first embodiment, but in the present embodiment the MCU has the specific feature corresponding to a stereo format.

In FIG. 14, numeral 1501 denotes an MCU (multipoint control unit) corresponding to the stereo format in the present invention. The MCU 1501 has a stereo signal processing capability and can perform the communication in the stereo communication system proposed in the first embodiment (this stereo communication system proposed in the first embodiment will be simply called the stereo communication system hereinafter).

In the stereo communication system, the (L+R)/2 signal (called a main audio signal hereinafter) obtained by the addition of the L and R audio signals and the (L−R)/2 signal (called a sub audio signal hereinafter) obtained by the subtraction of the L and R audio signals are first encoded, and the stereo signal is managed by using the encoded data, whereby the communication is performed.

In the data communication, the main audio signal is managed as the data being the G.723.1-encoded monaural audio to which the payload type has been defined.

Since the sub audio signal can not be managed as the conventional audio data, the nonstandard payload type is allocated thereto in the audio data communication.

The MCU 1501 is composed of one MC (multipoint controller) and one MP (multipoint processor) for processing audio data.

Three terminals A 1502, B 1503 and C 1504 participate in the group telephone and conference, and each terminal is point-point connected to the MCU 1501.

The terminals A 1502 and B 1503 are the video telephone and conference terminals corresponding to the stereo forma in the present invention. Like the MCU 1501, these terminals can perform the communication in the previously proposed stereo communication system.

Since the terminal C 1504 is the conventional video telephone and conference terminal, the audio of this terminal is monaural.

First, a procedure to start the group telephone and conference will be explained.

In order to start the group telephone and conference, the MC existing in the MCU 1501 performs setting to convene the conference.

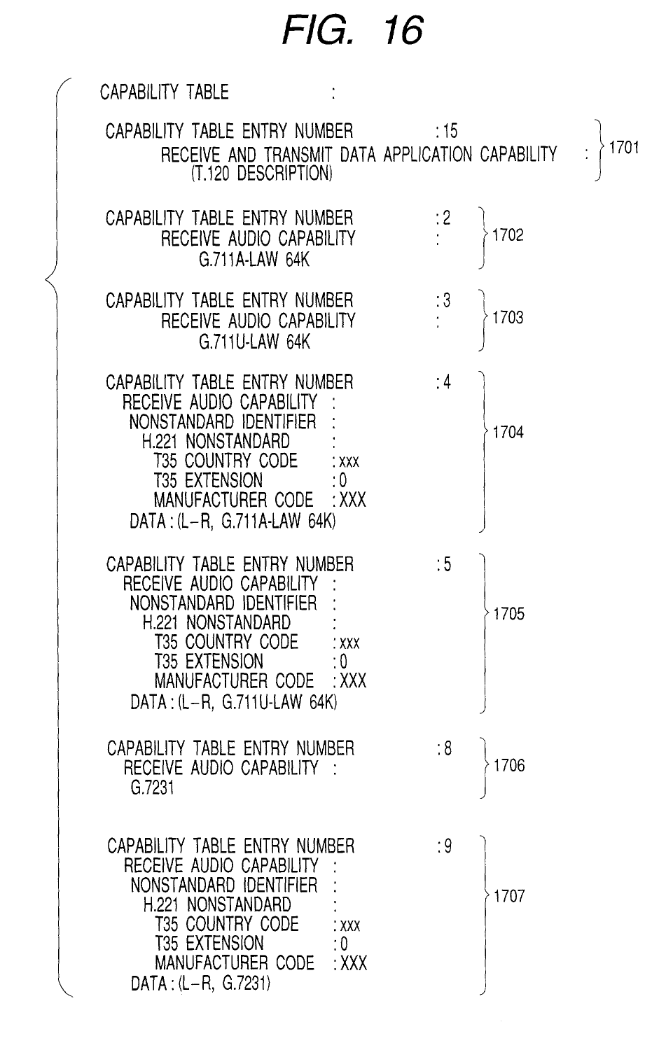

The terminal A 1502 performs call setting to the MC, and then performs capability exchange to other terminals according to H.245 Standard. Then, the terminal A 1502 transmits a capability table as shown in FIG. 16 to the MC so as to show the MC that this terminal can perform the communication with the conventional audio processing capability (monaural audio processing capability) and the stereo communication system.

The capability table in FIG. 16 will be briefly explained. A description 1701 indicates a data conference capability, a description 1702 indicates a capability for receiving audio G.711A-LAW, and a description 1703 indicates a capability for receiving audio G.711U-LAW. The capabilities indicated by the descriptions 1702 and 1703 are the capability for transmitting monaural audio of one channel based on G.711 Standard. The terminal A 1502 transmits the main audio signal by using this capability.

A description 1704 indicates a nonstandard audio data capability. Here, the sub audio signal encoded based on G711A-LAW Standard is managed. A description 1705 indicates a nonstandard audio data capability. Here, the sub audio signal encoded based on G711U-LAW Standard is managed.

A description 1706 indicates a capability for receiving audio G.723.1. This capability is used as the capability for encoding the main audio signal based on G.723.1 Standard and transmitting the encoded data.

A description 1707 indicates a nonstandard audio data capability. Here, the sub audio signal encoded based on G723.1 Standard is managed.

As described above, by the capability table, the terminal A 1502 shows the MC that this terminal has the conventional monaural audio processing capability and the data processing capability in the stereo communication system.

The terminal B 1503 is the terminal which corresponds to the stereo communication system, as well as the terminal A 1502. Thus, the terminal B 1503 similarly performs call setting to the MC and then performs capability exchange to other terminals according to H.245 Standard.

In the capability exchange, by using the capability table as shown in FIG. 16, the terminal B 1503 shows the MC that this terminal has the conventional monaural audio processing capability and the data processing capability in the stereo communication system.

The terminal C 1504 which is the conventional terminal for managing the monaural audio performs call setting to the MC and then performs capability exchange to other terminals according to H.245 Standard. In the capability exchange, by using the capability table, the terminal C 1504 shows the MC that this terminal is the terminal for managing the monaural audio.

As described above, between the MC and each of all the terminals participating in the group telephone and conference, the call setting and the subsequent capability exchange end. Thus, the MC integrates the capabilities of all the participants and determines the audio format used for the MCU 1501 to perform multicasting.

After the capability exchange between the MC and each terminal ended, setting of audio channel communication is performed. By using the previously determined data format (an encoding system, the number of channels, etc.) between each terminal and the MCU 1501, each terminal and the MCU 1501 mutually open RTP and RTCP channels and start data transmission.

Namely, the main audio channel, and the data channel (the RTP channel) and the data control channel (the RTCP channel) for the sub audio channel are respectively opened between the terminal using the stereo communication system and the MCU 1501.

On the other hand, only the data channel (the RTP channel) and the data control channel (the RTCP channel) for the main audio (monaural audio) are opened between the terminal managing the monaural signal and the MCU 1501, but any channel for the sub audio is not opened (such the channel can not be opened due to the terminal's capability). Therefore, unnecessary data in the LAN can be prevented from increasing. However, for example, in a case where the data quantity does not increase, or in a case where all the terminals participating in the group telephone and conference communicate by using the stereo communication system, the main and sub audio data may be communicated through one channel.

Next, internal blocks of the terminal A 1502 will be briefly explained.

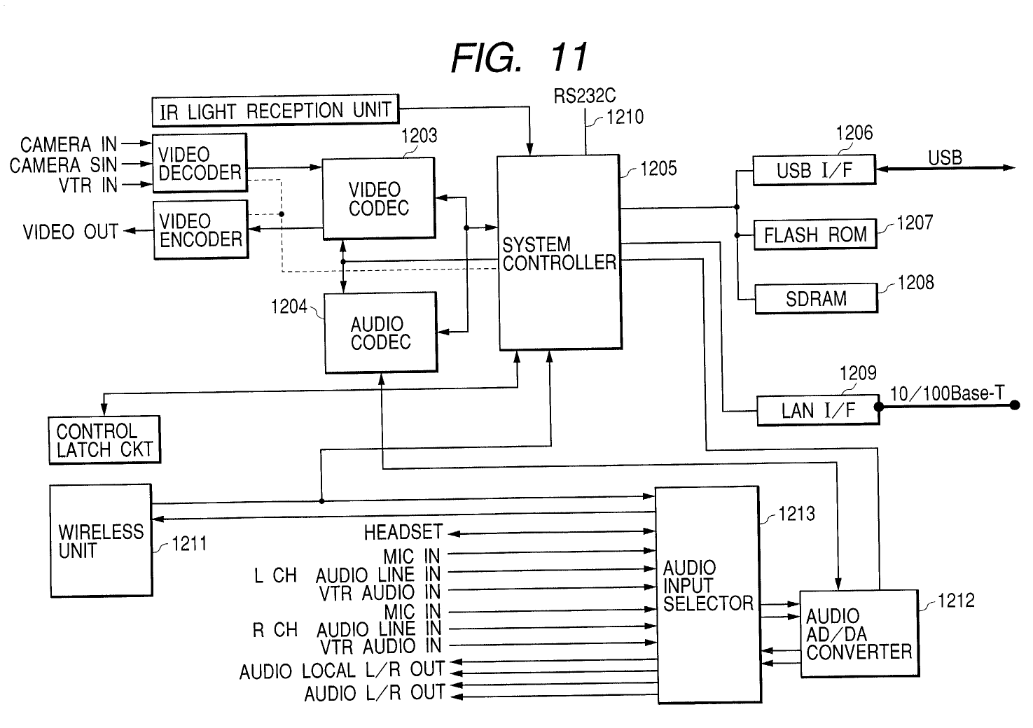

FIG. 11 shows the internal blocks in the terminal A 1502. Here, the terminal A 1502 is the video telephone and conference terminal which has the two audio channels for the L and R audio signals.

This terminal is controlled by a system controller 1205, and a video codec 1203 and an audio codec 1204 perform encoding and decoding of the respective data.

Programs for the system controller 1205, the video codec 1203 and the audio codec 1204 have been stored in a flash ROM 1207. Thus, after turning on a power supply, the system controller 1205 reads its program, loads it in an SDRAM 1208, and starts initialization of the terminal A 1502.

The programs for the video codec 1203 and the audio codec 1204 are read by the system controller 1205, loaded in an SRAM within each codec chip, whereby the programs start.

The audio is input through stereo microphones, a line input, headsets, a wireless telephone connected by a wireless unit 1211, and the like.

Information selected by a user is input to the terminal through an USB (Universal Serial Bus) I/F 1206, an RS-232C (Recommended Standard 232C) I/F 1210 or a LAN I/F 1209, and based on the input information the system controller 1205 select the audio input source by an audio input selector 1213.

The selected audio signal is digitized by an audio AD/DA converter 1212 and then input to the audio codec 1204.

For example, the audio codec 1204 performs audio data compression based on G723.1 Standard.

The compressed audio data is sent to the system controller 1205, subjected to a predetermined process, and then sent to a LAN through the LAN I/F 1209.

On the other hand, in the data reception, the data received through the LAN I/F 1209 is subjected to a predetermined process by the system controller 1205, and thus obtained audio data is sent to the audio codec 1204. If there is the video data, this data is sent to the video codec 1203.

The audio data is decoded by the audio codec 1204, converted into an analog signal by the audio AD/DA converter 1212, and output to an audio output device selected by the audio input selector 1213.

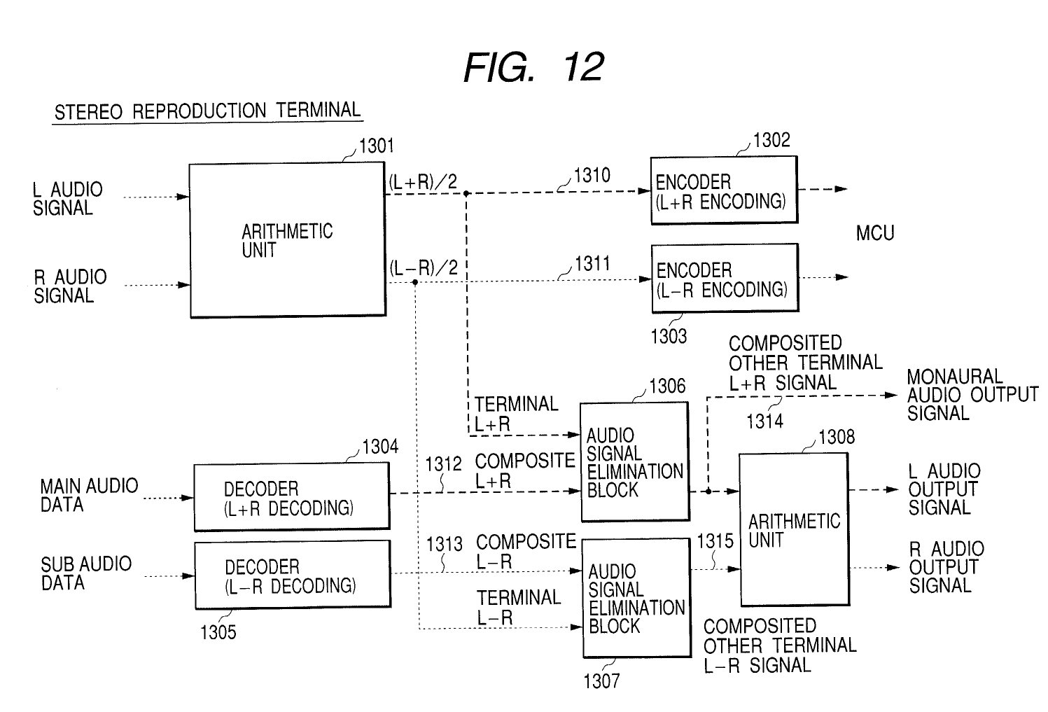

Next, an internal audio data process in the video telephone and conference terminal (the terminal A 1502) will be explained with reference to FIG. 12.

The terminal A 1502 is the terminal which performs the stereo signal process and uses the stereo communication system.

The L and R audio signals input to the terminal A 1502 are subjected to arithmetic operations by an arithmetic unit 1301 to generate a main audio signal ((L+R)/2 signal) 1310 and a sub audio signal ((L−R)/2 signal) 1311.

The main audio signal 1310 is encoded by an encoder 1302 based on G.723.1 Standard. The encoded data is defined as a monaural audio data type and transmitted to the MCU 1501.

On the other hand, the sub audio signal 1311 is encoded by an encoder 1303 based on G.723.1 Standard. The encoded data is defined as a nonstandard data type and transmitted to the MCU 1501.

The main audio data and the sub audio data which are obtained by appropriately compositing the audio of each of all the terminals (terminals A, B and C) participating in the group telephone and conference are received from the MCU 1501.

The main audio data received from the MCU 1501 is decoded by a decoder 1304, and thus a main audio signal 1312 is output. The sub audio data received from the MCU 1501 is decoded by a decoder 1305, and thus a sub audio signal 1313 is output.

The main audio signal or the sub audio signal is the main audio signal or the sub audio signal obtained by appropriately compositing the audio of each of all the terminals A 1502, B 1503 and C 1504. Namely, the audio of the terminal A 1502 is composited in the main or sub audio signal. For this reason, it is necessary to reproduce the audio signal from which the audio of the terminal A 1502 has been eliminated, in order to prevent howling tones.

Thus, the main audio signal 1310 from the terminal A 1502 and the main audio signal 1312 from the MCU 1501 obtained by compositing the audio of each of all the terminals are input to an audio signal elimination block 1306, whereby the audio signal of the terminal A 1502 is eliminated.

An audio signal 1314 output from the audio signal elimination block 1306 is the signal obtained by compositing the audio signals of the terminals B 1503 and C 1504.

Also, since the audio signal 1314 is the monaural signal, it is possible to output this signal 1314 when the audio output of the terminal is monaural such as the headset or the like.

Similarly, the sub audio signal 1311 from the terminal A 1502 and the sub audio signal 1313 from the MCU 1501 are input to an audio signal elimination block 1307, whereby the sub audio signal of the terminal A 1502 is eliminated.

In the audio signal elimination block, the audio signal of its own terminal is eliminated by, e.g., an elimination method using correlation of the audio signals.

An output signal 1315 of the audio signal elimination block 1307 and the main audio signal 1314 are input to an arithmetic unit 1304. The arithmetic unit 1304 performs simple arithmetic operations for these signals and outputs the L and R audio signals.

Thus, when the audio output of the terminal A 1502 is stereo such as the speaker or the like, the L and R audio signals are output, whereby the stereo signal can be reproduced.

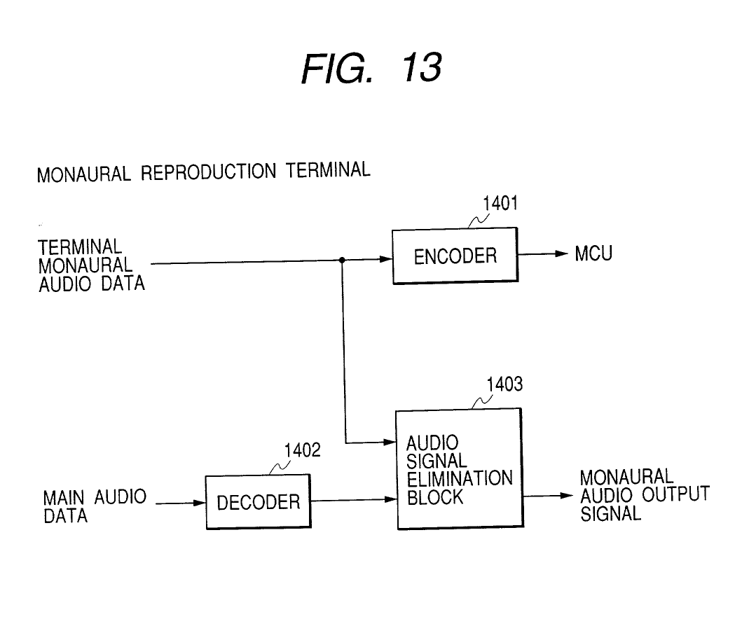

Next, FIG. 13 shows an audio data processing method in a monaural terminal such as the terminal C 1504.

The audio signal of the terminal is encoded by an encoder 1401, and then transmitted to the MCU 1501. Further, the received main audio data is decoded by a decoder 1402, and then input to an audio signal elimination block 1403 so as to eliminate the terminal's own audio. Thus, the signal from which the terminal's own audio has been eliminated is output from the audio signal elimination block 1403, and this audio signal is managed as the monaural audio output signal.

Next, the internal process of the MCU 1501 will be explained.

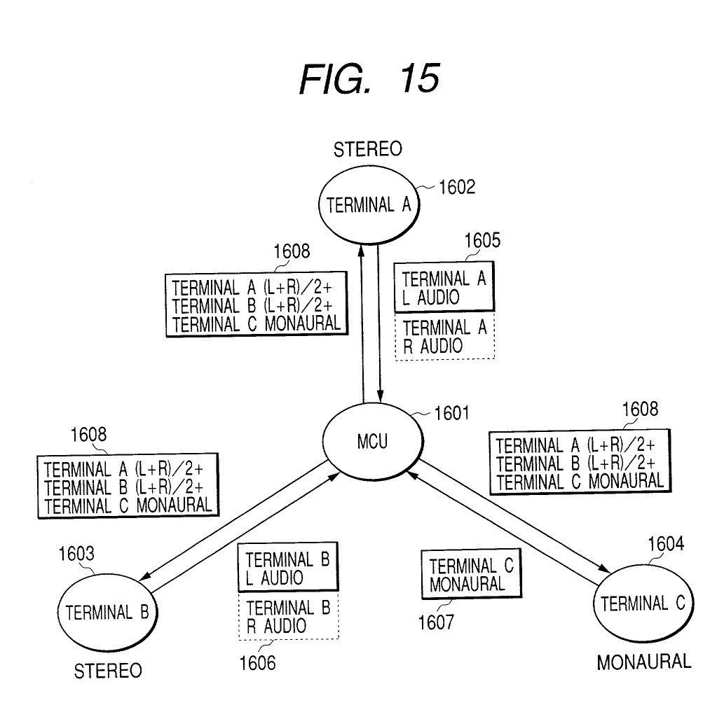

As shown in FIG. 15, the MCU 1501 receives the plural audio data from the three terminals. Namely, main and sub audio data 1505 are received from the terminal A 1502, main and sub audio data 1506 are received from the terminal B 1503, and monaural audio data 1507 is received from the terminal C 1504.

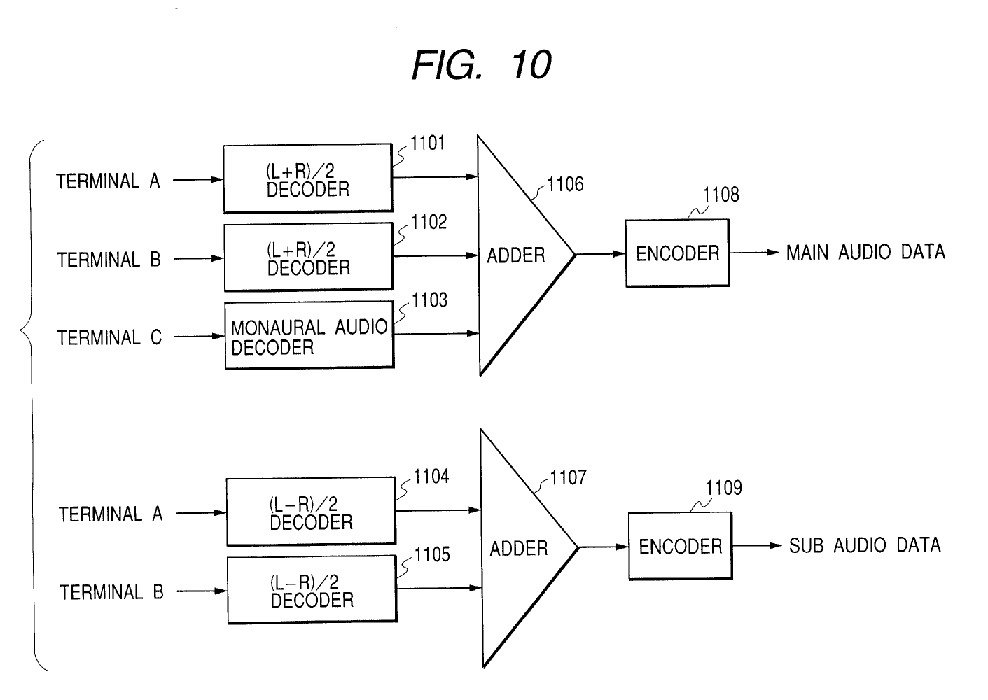

FIG. 10 shows the audio process within the MCU 1501.

The MCU 1501 decodes the plural received data, adds main and sub audio data to the decoded data, encodes the addition-result data, and performs multicasting of the encoded data.

Concretely, the following three kinds of audio signals, i.e., the main audio signal of the terminal A 1502 decoded by a decoder 1101, the main audio signal of the terminal B 1503 decoded by a decoder 1102, and the monaural signal of the terminal C 1504 decoded by a decoder 1103, are input to an adder 1106 which performs the addition of the main audio signals.

Further, the following two kinds of audio signals, i.e., the sub audio signal of the terminal A 1502 decoded by a decoder 1104, and the sub audio signal of the terminal B 1503 decoded by a decoder 1105, are input to an adder 1107 which performs the addition of the sub audio signals.

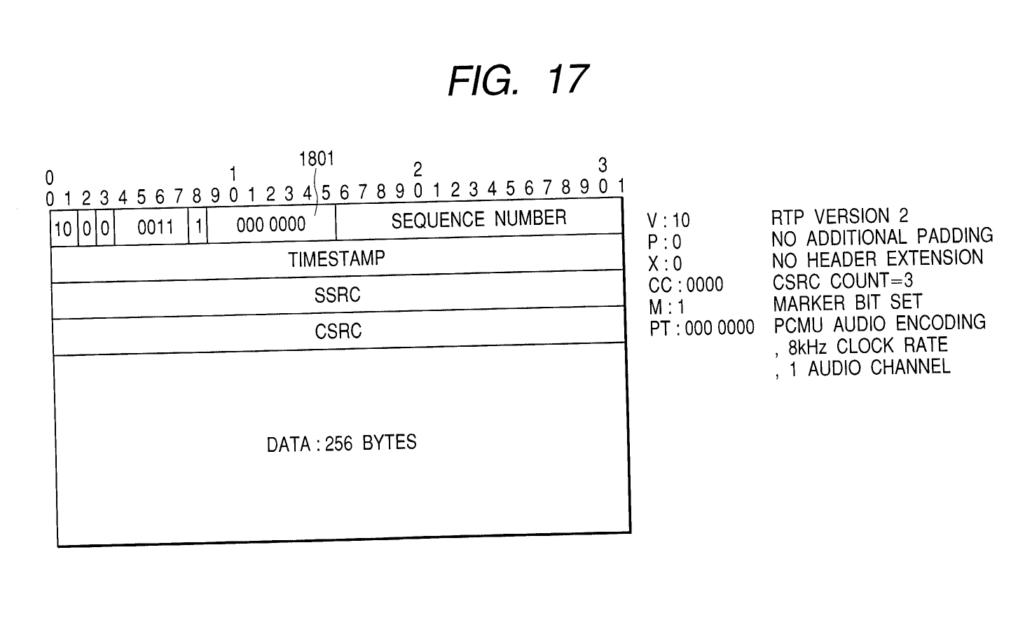

A main audio signal 1508 output from the adder 1106 which performs the addition of the main audio signals is encoded by an encoder 1108, and then multicast from the MCU 1501 to the respective terminals. An example of a packet of the data multicast from the MCU 1501 is shown in FIG. 17.

The packet shown in FIG. 17 corresponds to one-channel monaural data of 8 kHz sampling encoded according to G.711U-LAW Standard. Since the payload type of this data is defined as “0”, values “0” are described in a payload type 1801 of the packet.

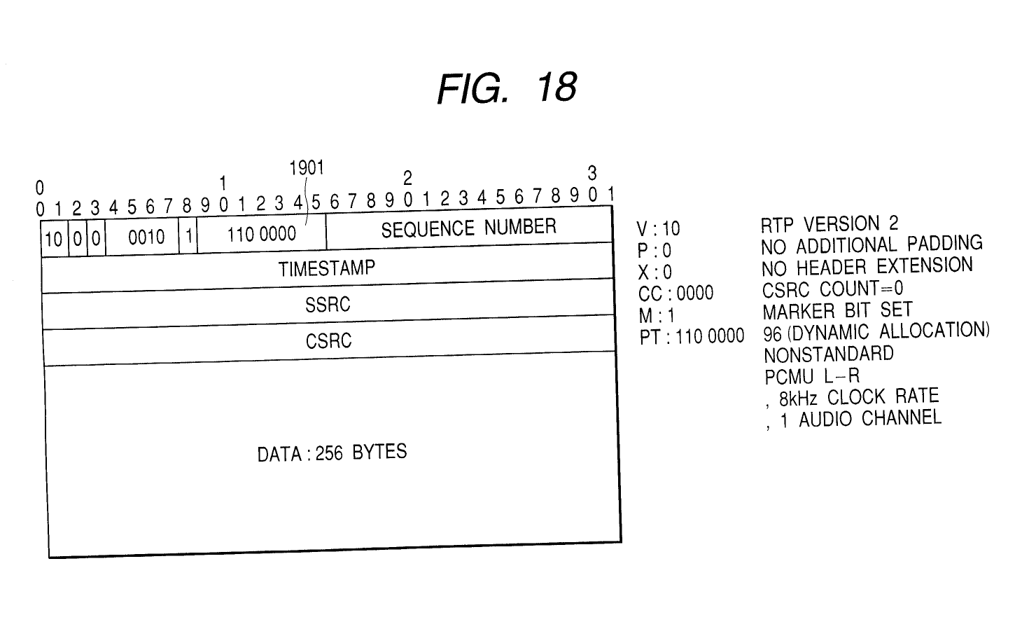

Further, a sub audio signal 1509 output from the adder 1107 which performs the addition of the sub audio signals is encoded by an encoder 1109, and then multicast from the MCU 1501 to the respective terminals. An example of a packet of the data multicast from the MCU 1501 is shown in FIG. 18.

The packet shown in FIG. 18 corresponds to one-channel audio data of 8 kHz sampling encoded according to G.711U-LAW Standard. Since this data is obtained by encoding a difference signal between the L and R audio signals, only this data itself can not be reproduced as the audio signal. For this reason, this data is defined as the nonstandard audio, and the payload type of this data is dynamically allocated, i.e., values “96” are described in a payload type 1901 of the packet in FIG. 18.

Each of the terminals A 1502 and B 1503 reproducing the stereo signal receives the multicast main audio signal (FIG. 17) and sub audio signal (FIG. 18), and can reproduce the received signals as the stereo signal by using the blocks shown in FIG. 12.

On the other hand, the terminal C 1504 reproducing the monaural signal receives only the multicast main audio signal (FIG. 17), and can reproduce the received audio of the group telephone and conference as the monaural signal by eliminating the terminal C's own audio.

As explained above, according to the present embodiment, the MCU 1501 corresponding to the stereo format of the present invention performs the mutual communication of the audio data by using the stereo communication system. By doing so, even if the terminals corresponding to the stereo signal and the terminals corresponding to the monaural signal are mixedly connected mutually, the terminal corresponding to the stereo signal can manage the stereo signal without matching its capability with the capability of the terminal corresponding to the monaural signal. Besides, the terminal corresponding to the monaural signal can participate in the group telephone and conference using such the mutual communication, as it remains its conventional function.

[Third Embodiment]

As an MCU corresponding to a stereo format in the present embodiment, the function of the MCU in the second embodiment is achieved by one of the terminals participating in the group telephone and conference.

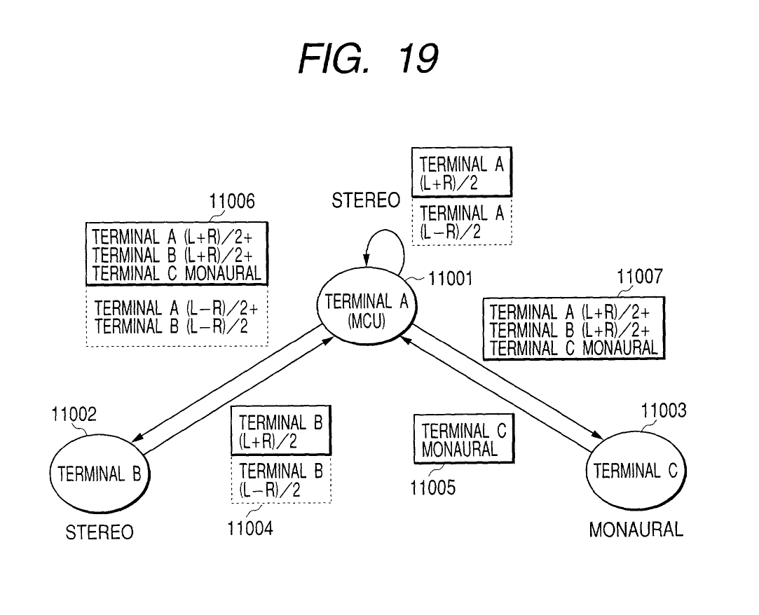

FIG. 19 shows connection in a case where, when a stereo terminal A 11001, a stereo terminal B 11002 and a monaural terminal C 11003 together perform the group telephone and conference, the terminal A 11001 achieves the MCU function within the terminal itself. In FIG. 19, the terminal A 11001 having the MCU function is point-point connected to the terminal B 11002, and the terminal A 11001 is further point-point connected to the terminal C 11003.

The terminal A 11001 is the video telephone and conference terminal corresponding to the stereo format according to the present invention, and the terminal C 11003 is the conventional video telephone and conference terminal of which audio is managed by the monaural audio signal.

A procedure to start the group telephone and conference is as follows.

In order to start the group telephone and conference, an MC existing in the terminal A 11001 and being the part of the MCU function performs setting to convene the conference.

The terminal A 11001 performs call setting to the MC existing in the terminal A 11001 itself, and then performs capability exchange to other terminals according to H.245 Standard. Then, the terminal A 11001 transmits a capability table to the MC so as to show the MC that this terminal can perform the communication with the conventional audio processing capability (monaural audio processing capability) and the communication according to the stereo communication system.

Next, the terminal B 11002 similarly performs call setting to the MC existing in the terminal A 11001, and then performs capability exchange to other terminals according to H.245 Standard. Then, the terminal B 11002 transmits a capability table to the MC so as to show the MC that this terminal can perform the communication with the conventional monaural audio processing capability and the communication according to the stereo communication system.

Next, the terminal C 11003 similarly performs call setting to the MC existing in the terminal A 11001, and then performs capability exchange to other terminals according to H.245 Standard. In the capability exchange, by using a capability table, the terminal C 11003 shows the MC that this terminal is the terminal for managing the monaural audio.

As described above, between the MC and each of all the terminals participating in the group telephone and conference, the call setting and the subsequent capability exchange according to H.2445 Standard end. Thus, the MC integrates the capabilities of all the participants and determines the audio format used for the MCU (i.e., the terminal A 11001) to perform multicasting.

After the capability exchange between the MC and each terminal ended, setting of audio channel communication is performed. By using the previously determined data format (an encoding system, the number of channels, etc.) between each terminal and the MCU, the MCU and the terminal B 11002 and the MCU and the terminal C 11003 mutually open RTP and RTCP channels and start data transmission.

Namely, the main audio channel, and the data channel (the RTP channel) and the data control channel (the RTCP channel) for the sub audio channel are respectively opened between the terminal B 11002 using the stereo communication system and the MCU (the terminal A 11001). The data to be transmitted from the terminal B 11002 to the MCU (the terminal A 11001) is the main audio data and the sub audio data (11004), and the data to be transmitted from the terminal A 11001 to the terminal B 11002 is main audio data and sub audio data 11006 in which the participant's audio of the group telephone and conference is composited.

On the other hand, only the data channel (the RTP channel) and the data control channel (the RTCP channel) for the main audio (monaural audio) are opened between the terminal C 11003 managing the monaural signal and the MCU (the terminal A 11001), but any channel for the sub audio is not opened (such the channel can not be opened due to the terminal's capability). Thus, the data to be transmitted from the terminal C 11003 to the MCU (the terminal A 11001) is monaural data 11005, and the data to be transmitted from the terminal A 11001 to the terminal C 11003 is the main audio data (monaural data) 11007 in which the participant's audio of the group telephone and conference is composited.

Since the data transmitted from the terminal A 11001 to the terminal C 11003 may be only the main audio data, unnecessary data in the LAN can be prevented from increasing. However, for example, in a case where the data quantity does not increase, or in a case where all the terminals participating in the group telephone and conference communicate by using the stereo communication system, the main and sub audio data may be communicated through one channel.

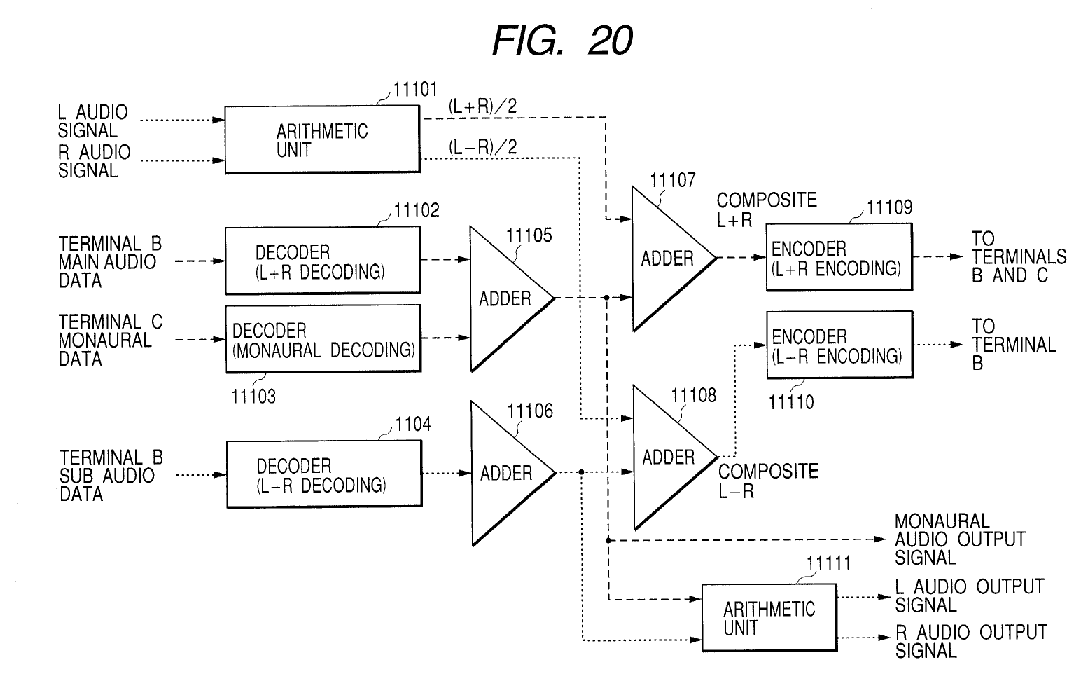

Next, internal blocks of the terminal A 11001 will be briefly explained with reference to FIG. 20. As described above, the terminal A 11001 is the video telephone and conference terminal which corresponds to the stereo format and has the MCU function.

The terminal A 11001 is the terminal having the stereo signal processing capability. The L and R audio signals are input as the audio input, and the main and sub audio signals of this terminal itself are generated by an arithmetic unit 11101.

On the other hand, as the data received from another terminals, the main audio signal is input from the terminal B 11002, and the monaural audio data is received from the terminal C 11003. The main audio signal input from the terminal B 11002 is decoded by a decoder 11102 and input to an adder 11105, and the monaural audio data input from the terminal C 11003 is decoded by a decoder 11103 and input to the identical adder 11105. The audio of the terminal B 11002 and the audio of the terminal C 11003 are composited and thus the composited audio signal is output by the adder 11105. This audio signal is also the monaural signal which is output as the audio from the terminal A 11001.

As the sub audio signal received from another terminal, the sub audio signal received from the terminal B 11002 is decoded by a decoder 11104 and input to an adder 11106. Since there is no other input to the adder 11106, the sub audio signal of the terminal B 11002 is output as it is. This output signal from the adder 11106 is also the sub audio signal which is output as the audio from the terminal A 11001.

The audio output signal of the terminal A 11001 is generated from the output signal of the adder 11105 obtained by compositing the main audio signal of the terminal B 11002 and the monaural signal of the terminal C 11003, and the output signal of the adder 11106 being the sub audio signal of the terminal B 11002. The audio signals output from the adders 11105 and 11106 are input to an arithmetic unit 11111, whereby the L and R audio output signals for stereo reproduction can be obtained from the main and sub audio signals. Since the terminal A 11001 has the MCU function, as described above, any block for eliminating the audio signal of this terminal itself is unnecessary, whereby it is possible to remarkably reduce a quantity of the operations.

The data to be broadcast by the terminal A 11001 is created and generated as follows.

Namely, in order to composite the main audio signal of the terminal A 11001 to the output signal of the adder 11105, the above two signals are input to an adder 11107. The output from the adder 11107 is encoded by an encoder 11109 according to a predetermined encoding method, whereby the main audio data to be broadcast can be obtained. On the other hand, the output from the adder 11106 and the sub audio signal of the terminal A 11001 are input to an adder 11108 for audio compositing. The output from the adder 11108 is encoded by an encoder 11110 according to a predetermined encoding method, whereby the sub audio data to be broadcast can be obtained. In the present embodiment, the main audio data is transmitted to the terminal B 11002 and the terminal C 11003, and the sub audio data is transmitted to only the terminal B 11002.

The terminal B 11002 receives the audio-composited main and sub audio data from the terminal A 11001, decodes the received data, eliminates the audio of the terminal B itself, and restores the L and R audio signals, whereby the stereo signal can be reproduced.

On the other hand, the terminal C 11003 receives only the audio-composited main audio data from the terminal A 11001, decodes the received data, eliminates the audio of the terminal C itself, and restores the audio, whereby the monaural signal can be reproduced.

As described above, even in the group telephone and conference in which the stereo and monaural terminals mixedly participate, the stereo terminal can perform the communication of the stereo audio, and the conventional monaural terminal can perform the communication of the monaural audio without providing any additional function.

The present invention includes a situation that a memory medium storing program codes of software to realize the functions of the above embodiments is supplied to a system or an apparatus and then a computer (or CPU or MPU) of the system or the apparatus reads and executes these program codes.

In this case, the program codes themselves realize the functions of the above embodiments. Thus, the program codes themselves and a means for supplying these program codes to the computer, e.g., a recording medium storing these program codes, constitute the present invention. As the recording medium storing these program codes, e.g., a floppy disk, a hard disk, an optical disk, a magnetooptical disk, a CD-ROM, a magnetic tape, a nonvolatile memory card, a ROM or the like can be used.

Each of the above embodiments merely shows one concrete example in the case where the present invention is executed. Thus, the technical scope of the present invention must not be interpreted definitely in accordance with these embodiments. Namely, the present invention is enforceable in various manners without being deviated from its scope and main feature.

As described above, according to the present invention, it is possible in the video conference and video telephone system or the like to deal with both the stereo audio reproduction and the monaural audio reproduction by performing the communication of the data obtained by the addition of the two audio signals of the L and R channels constituting the stereo audio and the data obtained by subtraction of these audio signals. Thus, in the multipoint conference in which the terminal devices each having the stereo audio processing capability and the terminal devices each having the monaural audio processing capability mixedly participate, it is possible between the terminal devices each having the stereo audio processing capability to restore or reproduce the stereo audio without increasing a data quantity and wastefully increasing processing capabilities.

Further, according to the present invention, even if the video telephone and conference terminal corresponding to the stereo format which performs by using the stereo communication system the communication of the data (main audio data) obtained by the addition of the two L and R audio signals and the data (sub audio data) obtained by the subtraction of these two audio signals and the conventional terminal which has the monaural signal processing capability mixedly exist, it is possible to perform the communication of the stereo format.

Further, even if the terminals managing the stereo signal and the terminals managing the monaural signal are mixedly connected mutually, the MCU of the present invention necessary in the group telephone and conference can manage the stereo signal without matching its capability with the capability of the terminal corresponding to the monaural signal (i.e., without integrating stereo audio and monaural audio into only monaural audio).

Further, the terminal performing the monaural signal process can participate in the group telephone and conference, as it remains its conventional function.

The present invention is not limited to the above embodiments. Namely, it is obvious that various modifications and changes are possible in the present invention within the spirit and scope of the appended claims.

What is claimed is:

1. A video conference and video telephone system which includes transmission and reception apparatuses for performing communication of two audio signals of L and R channels, wherein
said transmission apparatus comprises
transmission means for transmitting data obtained by addition of the two audio signals as first audio data through a first communication channel, and transmitting data obtained by subtraction of the two audio signals as second audio data through a second communication channel, and
said reception apparatus comprises
reception means for receiving the data obtained by the addition of the two audio signals as the first audio data and the data obtained by the subtraction of the two audio signals as the second audio data, and
restoring means for restoring the audio signal by performing an arithmetic operation on the basis of the audio data received by said reception means.

2. A system according to claim 1, wherein
the first audio data represents monaural audio and the second audio data represents stereo audio,
said transmission means of said transmission apparatus transmits, according to whether an audio source of said transmission apparatus is the stereo audio or the monaural audio, a change of the audio source to said reception apparatus, and
said restoring means of said reception apparatus restores the audio signal on the basis of the first audio data obtained by the addition of the two audio signals and the second audio data obtained by the subtraction of the two audio signals when the audio source of said transmission apparatus is the stereo audio, and restores the audio signal on the basis of only the first audio data obtained by the addition of the two audio signals when the audio source of said transmission apparatus is the monaural audio.

3. A system according to claim 1, wherein said transmission means of said transmission apparatus transmits the number of audio channels of said transmission apparatus to said reception apparatus, as describing it at a source description of an RTCP (real time control protocol) packet.

4. A system according to claim 1, wherein said transmission means of said transmission apparatus transmits a type of audio input device of said transmission apparatus to said reception apparatus, as describing it at a source description of an RTCP packet.

5. A system according to claim 1, wherein each of said transmission apparatus and said reception apparatus has notification means for notifying its own capability by using a mode request message according to H.245 Standard of ITU-T (International Telecommunication Union Telecommunication Standardization Sector) Recommendation.

6. A system according to claim 1, wherein
said transmission means of said transmission apparatus adjusts the number of channels to be used for the transmission, according to the kind of audio source of said transmission apparatus, and
said reception means of said reception apparatus adjusts the number of channels to be used for the reception, according to the number of channels to be used for the transmission.

7. A transmission apparatus comprising:
first generation means for generating packet data obtained by addition of two audio signals of L and R channels;
second generation means for generating packet data obtained by subtraction of the two audio signals; and
transmission means for transmitting the packet data generated by said first generation means through a first communication channel, and transmitting the packet data generated by said second generation means through a second communication channel.

8. A reception apparatus comprising:
reception means for receiving packet data obtained by addition of two audio signals of L and R channels and/or packet data obtained by subtraction of the two audio signals; and
restoring means for restoring the audio signal by performing an arithmetic operation on the basis of the packet data received by said reception means.

9. An apparatus according to claim 8, wherein said restoring means restores a stereo audio signal on the basis of the packet data obtained by the addition of the two audio signals and the packet data obtained by the subtraction of the two audio signals when stereo audio is restored, and restores a monaural audio signal on the basis of only the packet data obtained by the addition of the two audio signals when monaural audio is restored.

10. A communication apparatus comprising:
transmission means for transmitting packet data obtained by addition of two audio signals of L and R channels through a first communication channel, and transmitting packet data obtained by subtraction of the two audio signals through a second communication channel;
reception means for receiving the packet data obtained by the addition of the two audio signals of the L and R channels and/or the packet data obtained by the subtraction of the two audio signals; and
restoring means for restoring the audio signal by performing an arithmetic operation on the basis of the packet data received by said reception means.

11. An apparatus according to claim 10, wherein said restoring means restores a stereo audio signal on the basis of the packet data obtained by the addition of the two audio signals and the packet data obtained by the subtraction of the two audio signals when stereo audio is restored, and restores a monaural audio signal on the basis of only the packet data obtained by the addition of the two audio signals when monaural audio is restored.

12. A communication method comprising:
a first generation step of generating packet data obtained by addition of two audio signals of L and R channels;
a second generation step of generating packet data obtained by subtraction of the two audio signals; and
a transmission step of transmitting the packet data generated in said first generation step through a first communication channel, and transmitting the packet data generated in said second generation step through a second communication channel.

13. A communication method comprising:
(a) a step of receiving packet data obtained by addition of two audio signals of L and R channels and/or packet data obtained by subtraction of the two audio signals; and
(b) a step of restoring the audio signal by performing an arithmetic operation on the basis of the packet data received in said reception step (a).

14. A communication method comprising:
(a) a step of transmitting packet data obtained by addition of two audio signals of L and R channels through a first communication channel, and transmitting packet data obtained by subtraction of the two audio signals through a second communication channel;
(b) a step of receiving the packet data obtained by the addition of the two audio signals of the L and R channels and/or the packet data obtained by the subtraction of the two audio signals; and
(c) a step of restoring the audio signal by performing an arithmetic operation on the basis of the packet data received in said reception step (b).

15. A recording medium which stores a program to cause a computer to execute following procedures:
the first generation procedure of generating packet data obtained by addition of two audio signals of L and R channels;
the second generation procedure of generating packet data obtained by subtraction of the two audio signals; and
the transmission procedure of transmitting the packet data generated in said first generation procedure through a first communication channel, and transmitting the packet data generated in said second generation procedure through a second communication channel.

16. A recording medium which stores a program to cause a computer to execute following procedures:
(a) the procedure of receiving packet data obtained by addition of two audio signals of L and R channels and/or packet data obtained by subtraction of the two audio signals; and
(b) the procedure of restoring the audio signal by performing an arithmetic operation on the basis of the packet data received in said reception procedure (a).

17. A recording medium which stores a program to cause a computer to execute following procedures:
(a) the procedure of transmitting packet data obtained by addition of two audio signals of L and R channels through a first communication channel, and transmitting packet data obtained by subtraction of the two audio signals through a second communication channel;
(b) the procedure of receiving the packet data obtained by the addition of the two audio signals of the L and R channels and/or the packet data obtained by the subtraction of the two audio signals; and
(c) the procedure of restoring the audio signal by performing an arithmetic operation on the basis of the packet data received in said reception procedure (b).

18. An image communication system which is composed of transmission and reception apparatuses performing communication of two audio signals of L and R channels, wherein
said transmission apparatus comprises
reception means for receiving, from an external apparatus, the two audio signals of the L and R channels and a monaural audio signal,
transmission means for transmitting data obtained by addition of the received two audio signals and monaural audio signal as first audio data through a first communication channel, and transmitting data obtained by subtraction of the two audio signals as second audio data through a second communication channel, and
said reception apparatus comprises
reception means for receiving the data obtained by the addition of the two audio signals and monaural audio signal as the first audio data and the data obtained by the subtraction of the two audio signals as the second audio data, and
restoring means for restoring a stereo audio signal on the basis of the first and second audio data received by said reception means.

19. A communication apparatus which performs communication with plural external apparatuses, comprising:
reception means for receiving, from the external apparatus, two audio signals of L and R channels or a monaural audio signal;
generation means for generating first audio data by addition of the received two audio signals and monaural audio signal and second audio data by subtraction of the two audio signals; and
transmission means for transmitting the first and second audio data.

20. An apparatus according to claim 19, wherein said transmission means transmits the first audio data through a first communication channel and the second audio data through a second communication channel.

21. An apparatus according to claim 19, wherein
when the external apparatus at a transmission destination of said transmission means corresponds to stereo audio, said transmission means transmits the first and second audio data to said transmission destination, and
when the external apparatus at the transmission destination of said transmission means corresponds to monaural audio, said transmission means transmits the first audio data to said transmission destination without transmitting the second audio data.

22. An apparatus according to claim 19, further comprising image data communication means for transmitting and receiving image data.

23. A communication method for an image communication system which is composed of transmission and reception apparatuses performing communication of two audio signals of L and R channels, wherein
in the transmission apparatus, said method comprises
a reception step of receiving, from an external apparatus, the two audio signals of the L and R channels and a monaural audio signal, and
a transmission step of transmitting data obtained by addition of the received two audio signals and monaural audio signal as first audio data through a first communication channel, and transmitting data obtained by subtraction of the two audio signals as second audio data through a second communication channel, and
in the reception apparatus, said method further comprises
a reception step of receiving the data obtained by the addition of the two audio signals and monaural audio signal as the first audio data and the data obtained by the subtraction of the two audio signals as the second audio data, and
a restoring step of restoring a stereo audio signal on the basis of the first and second audio data received in said reception step.

24. A communication method for a communication apparatus which performs communication with plural external apparatuses, comprising:
a reception step of receiving, from the external apparatus, two audio signals of L and R channels or a monaural audio signal;
a generation step of generating first audio data by addition of the received two audio signals and monaural audio signal and second audio data by subtraction of the two audio signals; and
a transmission step of transmitting the first and second audio data.

25. A method according to claim 24, wherein said transmission step transmits the first audio data through a first communication channel and the second audio data through a second communication channel.

26. A method according to claim 24, wherein
when the external apparatus at a transmission destination in said transmission step corresponds to stereo audio, said transmission step transmits the first and second audio data to said transmission destination, and
when the external apparatus at the transmission destination in said transmission step corresponds to monaural audio, said transmission step transmits the first audio data to said transmission destination without transmitting the second audio data.

27. A method according to claim 24, further comprising an image data communication step of transmitting and receiving image data.

28. A program which causes a computer to achieve a communication method comprising:
a first generation step of generating packet data obtained by addition of two audio signals of L and R channels;
a second generation step of generating packet data obtained by subtraction of the two audio signals; and
a transmission step of transmitting the packet data generated in said first generation step through a first communication channel, and transmitting the packet data generated in said second generation step through a second communication channel.

29. A program which causes a computer to achieve a communication method for an image communication system which is composed of transmission and reception apparatuses performing communication of two audio signals of L and R channels, wherein
in the transmission apparatus, said method comprises
a reception step of receiving, from an external apparatus, the two audio signals of the L and R channels and a monaural audio signal, and
a transmission step of transmitting data obtained by addition of the received two audio signals and monaural audio signal as first audio data through a first communication channel, and transmitting data obtained by subtraction of the two audio signals as second audio data through a second communication channel, and
in the reception apparatus, said method further comprises
a reception step of receiving the data obtained by the addition of the two audio signals and monaural audio signal as the first audio data and the data obtained by the subtraction of the two audio signals as the second audio data, and
a restoring step of restoring a stereo audio signal on the basis of the first and second audio data received in said reception step.
